(19) United States
(12) Patent Application Publication
(10) Pub. No.: US 2014/0197936 A1
(43) Pub. Date: Jul. 17, 2014

(54) FLEXURE, APPARATUS, SYSTEM AND METHOD

(71) Applicants: Silmon J. Biggs, Los Gatos, CA (US); Roger N. Hitchcock, San Leandro, CA (US); Anthony J. Obispo, Sunnyvale, CA (US); Ilya Polyakov, San Francisco, CA (US); Xina Quan, Saratoga, CA (US); Marcus A. Rosenthal, San Francisco, CA (US); Mikyong Yoo, Palo Alto, CA (US); Alireza Zarrabi, Sunnyvale, CA (US)

(72) Inventors: Silmon J. Biggs, Los Gatos, CA (US); Roger N. Hitchcock, San Leandro, CA (US); Anthony J. Obispo, Sunnyvale, CA (US); Ilya Polyakov, San Francisco, CA (US); Xina Quan, Saratoga, CA (US); Marcus A. Rosenthal, San Francisco, CA (US); Mikyong Yoo, Palo Alto, CA (US); Alireza Zarrabi, Sunnyvale, CA (US)

(21) Appl. No.: 13/979,869

(22) PCT Filed: Jan. 17, 2012
(86) PCT No.: PCT/US2012/021506

§ 371 Date: Jan. 2, 2014

Related U.S. Application Data
(60) Provisional application No. 61/433,640, filed on Jan. 18, 2011.
(60) Provisional application No. 61/433,655, filed on Jan. 18, 2011.
(60) Provisional application No. 61/442,913, filed on Feb. 15, 2011.
(60) Provisional application No. 61/477,712, filed on Apr. 21, 2011.
(60) Provisional application No. 61/477,680, filed on Apr. 21, 2011.
(60) Provisional application No. 61/493,123, filed on Jun. 3, 2011.
(60) Provisional application No. 61/493,588, filed on Jun. 6, 2011.
(60) Provisional application No. 61/494,096, filed on Jun. 7, 2011.

(51) Int. Cl. G08B 6/00

(52) U.S. Cl. CPC G08B 6/00
USPC 340/407.1

(57) ABSTRACT

An actuator module is disclosed. The actuator module includes an actuator having at least one elastomeric dielectric film disposed between first and second electrodes. A suspension system having at least one flexure is coupled to the actuator. The flexure enables the suspension system to move in a predetermined direction when the first and second electrodes are energized. A mobile device that includes the actuator module and a flexure where the actuator module assembly is used to provide haptic feedback also are disclosed.

### CROSS REFERENCE TO RELATED APPLICATION

This application claims the benefit, under 35 USC §119(e), of U.S. provisional patent application Nos. 61/433,640, filed Jan. 18, 2011, entitled “FRAMELESS DESIGN CONCEPT AND PROCESS FLOW”; 61/433,655, filed Jan. 18, 2011, entitled “SLIDING MECHANISM AND AMI ACTUATOR INTEGRATION”; 61/442,913 filed Feb. 15, 2011, entitled “FRAME-LESS DESIGN”; 61/477,680, filed Apr. 21, 2011, entitled “Z-MODE BUMPERS”; 61/477,712 filed Apr. 21, 2011, entitled “FRAMELESS APPLICATION”; 61/493,123, filed Jun. 3, 2011, entitled “ ” FLEXURE SYSTEM DESIGN”; 61/493,588, filed Jun. 6, 2011, entitled “ELECTRICAL BATTERY CONNECTION”; and 61/494,096, filed Jun. 7, 2011, entitled “BATTERY VIBRATOR FLEXURE WITH METAL BATTERY CONNECTOR FLEXURE”; the entire disclosure of each of which is hereby incorporated by reference.

### FIELD OF THE INVENTION

In various embodiments, the present disclosure relates generally to apparatuses, systems, and methods for integrating an actuator to efficiently couple its motion to another object. More specifically, the present disclosure relates to an actuator module integrated with a mobile device for moving and/or vibrating surfaces and components of the mobile device. In particular, this actuator module is appropriate to provide haptic feedback to the user of the mobile device.

### BACKGROUND OF THE INVENTION

Some hand held mobile devices and gaming controllers employ conventional haptic feedback devices using small vibrators to enhance the user's gaming experience by providing force feedback vibration to the user while playing video games. A game that supports a particular vibrator can cause the mobile device or gaming controller to vibrate in select situations, such as when firing a weapon or receiving damage to enhance the user's gaming experience. While such vibrators are adequate for delivering the sensation of large engines and explosions, they are quite monotonic and require a relatively high minimum output threshold. Accordingly, conventional vibrators cannot adequately reproduce finer vibrations. Besides low vibration response bandwidth, additional limitations of conventional haptic feedback devices include bulkiness and heaviness when attached to a mobile device such as a smartphone or gaming controller.

To overcome these and other challenges experienced with conventional haptic feedback devices, the present disclosure provides Electroactive Polymer Artificial Muscle (EPAM™) based haptic feedback on dielectric elastomers that have the bandwidth and the energy density required to make haptic displays that are both responsive and compact. Such EPAM™ haptic feedback modules comprise a thin sheet, which comprises a dielectric elastomer film sandwiched between two electrode layers. When a high voltage is applied to the electrodes, the two attracting electrodes compress the entire sheet. The EPAM™ based haptic feedback device provides a slim, low-powered haptic module that can be placed underneath an inertial mass (such as a battery) on a suspension tray to provide haptic feedback. The haptic feedback device may be driven by the host device audio signal which may be filtered or processed between 50 Hz and 300 Hz (with a 5 ms response time) to optimize the sensation experienced by the user.

### SUMMARY OF THE INVENTION

In one embodiment of the present invention, an actuator module is provided. The module comprises an actuator comprising at least one elastomeric dielectric film disposed between first and second electrodes. A suspension system comprising at least one flexure is coupled to the actuator. The flexure enables the suspension system to move in a predetermined direction when the first and second electrodes are energized. The actuator module system is particularly well suited to provide haptic feedback capability to mobile devices.

### BRIEF DESCRIPTION OF THE FIGURES

The present invention will now be described for purposes of illustration and not limitation in conjunction with the figures, wherein:

FIG. 1 is a cutaway view of an actuator system, according to one embodiment.

FIG. 2 is a schematic diagram of one embodiment of an EPAM actuator system to illustrate the principle of operation.

FIGS. 3A, 3B, 3C illustrate three possible configurations, one/three/six bar actuator arrays, according to various embodiments.

FIG. 4 is a schematic illustration of one embodiment of a haptic actuator array that may be adapted and configured into a moving touch surface sensor.

FIG. 5 is a schematic illustration of one embodiment of a haptic actuator array that may be adapted and configured into a device effector.

FIG. 6 is an exploded view of one embodiment of a flexure suspension system for a battery effector flexure tray.

FIG. 7 is a partial cutaway view of the flexure suspension system shown in FIG. 6.

FIG. 8 is a schematic illustration of one embodiment of the flexure suspension system shown in FIGS. 6 and 7 comprising a flexure tray.

FIG. 9 illustrates an X and Y axes vibration motion diagram 90 for modeling the motion of the flexure suspension system 60 shown in FIGS. 6-8 in the X and Y-directions.

FIG. 10 illustrates an X and Z axes vibration motion diagram for modeling the motion of the flexure suspension system shown in FIGS. 6-8 in the X and Z-directions.

FIG. 11 is a schematic diagram illustrating the flexure tray travel stop features of the flexure suspension system shown in FIGS. 6-8, according to one embodiment.

FIG. 12 is a schematic diagram of a flexure linkage beam model, according to one embodiment.

FIG. 13 illustrates one embodiment of a flexure tray without a battery.

FIG. 14 illustrates a segment of one embodiment of the flexure tray.

FIG. 15 illustrates one embodiment of a haptic actuator tape module formed on a flexible film rather a fixed rigid frame.

FIG. 16 illustrates one embodiment of the haptic actuator tape module mounted on a curved surface of a rigid/stiff substrate.

FIG. 17 is a top view of a flexure tray with an empty battery compartment defined by an opening, the flexures, and a flex cable portion of an actuator module protruding from a bottom portion of the flexure tray.

FIG. 18 is a bottom view of the flexure tray shown in FIG. 17 with an actuator module fixedly coupled to a bottom portion of the flexure tray.

FIG. 19 is a top view of the flexure tray shown in FIG. 17 with the battery located in the battery compartment.

FIG. 20 is a top view of a tablet computer integrated with at least one haptic actuator tape module.

FIG. 21 is a bottom view of the tablet computer with the rear cover removed to expose the battery compartment.

FIG. 22 illustrates a gaming controller mechanically integrated with one embodiment of a haptic module with both the battery pack cover and back cover of the gaming controller removed.

FIG. 23 illustrates the gaming controller shown in FIG. 22 with the back cover reinstalled.

FIG. 24 illustrates the gaming controller shown in FIG. 22 with the back cover and the battery pack cover reinstalled.

FIG. 25 is a perspective view of a mobile device integrated with a haptic module, according to one embodiment.

FIG. 26 is a side view of the mobile device shown in FIG. 25, according to one embodiment.

FIG. 27 is a top view of the mobile device shown in FIG. 25, according to one embodiment.

FIG. 28 is a back cover of the mobile device, according to one embodiment.

FIG. 29 is a perspective view of a mobile device comprising a touch surface and two main subassemblies, a display subassembly and a body subassembly, according to one embodiment.

FIG. 30 is a detail side view of the mobile device shown in FIG. 29, according to one embodiment.

FIG. 31 is a side view of the mobile device shown in FIG. 29 illustrating the direction of motion of the touch surface, according to one embodiment.

FIG. 32 is an exploded perspective view of one embodiment of the mobile device shown in FIG. 29, according to one embodiment.

FIG. 33 is an exploded side view of the mobile device shown in FIG. 29, according to one embodiment.

FIG. 34 is a perspective view of the body subassembly portion of the mobile device shown in FIG. 32 with the haptic actuator located therein, according to one embodiment.

FIG. 35 is a magnified partial perspective view of the body subassembly shown in FIG. 34, according to one embodiment.

FIG. 36 is a partial see-through side view of the display subassembly of the mobile device shown in FIG. 32, according to one embodiment.

FIG. 37 is a partial see-through side view of the display subassembly of the mobile device shown in FIG. 32, according to one embodiment.

FIG. 38 is a perspective view of a bottom housing portion of a mobile device comprising a battery effector, according to one embodiment.

FIG. 39 is a sectional view of the mobile device shown in FIG. 38, according to one embodiment

FIG. 40 is a partial detail sectional side of the mobile device shown in FIG. 38, according to one embodiment.

FIG. 41 is a perspective sectional view of a removable battery and a battery tray of the mobile device shown in FIG. 38, according to one embodiment.

FIG. 42 is a partial sectional view of the slide rails of a sliding mechanism of the mobile device shown in FIG. 38, according to one embodiment.

FIG. 43 is a top view of a battery effector with an actuator moving plate, according to one embodiment.

FIG. 44 is partial perspective view of the battery effector with the actuator moving plate shown in FIG. 43 and located above slide rails, according to one embodiment.

FIG. 45 is a partial perspective view of the battery effector shown in FIGS. 43-44 showing the position and orientation of the slide rails, according to one embodiment.

FIG. 46 is a partial perspective view of the battery effector shown in FIGS. 43-45 showing a haptic actuator located within a battery tray, according to one embodiment.

FIG. 47 is a bottom view of one embodiment of a mobile device integrated with a haptic module, according to one embodiment.

FIG. 48 is a detail view of an electrical spring connector for a battery coupled to a flexible circuit area and a grounded connection area, according to one embodiment.

FIG. 49 is a partial cut away view of a mobile device showing a battery tray, electrical spring connectors, and an interconnect flex cable, according to one embodiment.

FIG. 50 is a sectional view of an integrated flexure-battery connection system comprising a battery vibrator flexure utilizing a metal battery connector as a flexure, according to one embodiment.

FIG. 51 is a top view of the integrated flexure-battery connection system shown in FIG. 50.

FIG. 52 is a sectional side view of one embodiment of a Z-mode haptic actuator comprising a haptic actuator coupled to a first output bar, where the haptic actuator is de-energized.

FIG. 53 is a sectional side view of the Z-mode haptic actuator shown in FIG. 52, where the Z-mode haptic actuator is energized.

FIG. 54 is a sectional view of one embodiment of a Z-mode haptic bumper comprising a compliant bumper coupled to a de-energized haptic actuator.

FIG. 55 illustrates the haptic bumper shown in FIG. 54 in an energized state, i.e., the voltage is “on.”

FIG. 56 illustrates one embodiment of a haptic actuator in a de-energized state, i.e., the voltage is “off.”

FIG. 57 illustrates the haptic actuator shown in FIG. 56 in an energized state, i.e., the voltage is “on.”

FIG. 58 illustrates one embodiment of an integrated bumper and haptic actuator in a de-energized state, i.e., voltage “off.”

FIG. 59 illustrates one embodiment of the integrated bumper and haptic actuator shown in FIG. 56 in an energized state, i.e., voltage “on.”

FIG. 60 illustrates one embodiment of an external clip-on flexure for securing first and second plates of a haptic module.

FIG. 61 illustrates one embodiment of an internal clip-on flexure to secure top and bottom plates of a haptic module, according to various embodiments.

FIG. 62 illustrates one embodiment of an external clip-on flexure to secure top and bottom plates of a haptic module, according to various embodiments.

FIG. 63 illustrates one embodiment of an external clip-on flexure to secure first and second plates of a haptic module, according to various embodiments.

FIG. 64 illustrates one embodiment of an external clip-on flexure to secure top and bottom plates of a haptic module, according to various embodiments.

FIG. 65 is a perspective view of one embodiment of an external clip-on flexure secured to top and bottom plates of a haptic module, according to one embodiment.

FIG. 66 is a perspective view of one embodiment of an external clip-on flexure secured to top and bottom plates of a haptic module, according to one embodiment.

FIG. 67 is a rear view of one embodiment of a single flat metal component, which can be bent to form the external clip-on flexure described in connection with FIGS. 64-66.

FIG. 68 is a front view of one embodiment of a single flat metal component, which can be bent to form the external clip-on flexure described in connection with FIGS. 64-66.

FIG. 69 illustrates a detail front view of one end portion of the external clip-on flexure described in connection with FIGS. 64-66.

FIG. 70 is a detail side view of the external clip-on flexure along lines 70-70 in FIG. 69.

FIG. 71 is a schematic diagram representation of the deflection of a simple cantilever beam.

FIG. 72 is a graphical representation illustrating the agreement between theory and measurement of a steel flexure, plotted against values expected from EQ. 1.

FIGS. 73 and 74 are schematic diagrams of torsional springs.

FIG. 75 is a graphical representation of measurements of displacement versus reaction force.

FIG. 76 is a system diagram of an electronic control circuit for activating a haptic module from a sensor input.

### DETAILED DESCRIPTION OF THE INVENTION

Before explaining the disclosed embodiments in detail, it should be noted that the disclosed embodiments are not limited in application or use to the details of construction and arrangement of parts illustrated in the accompanying drawings and description. The disclosed embodiments may be implemented or incorporated in other embodiments, variations and modifications, and may be practiced or carried out in various ways. Further, unless otherwise indicated, the terms and expressions employed herein have been chosen for the purpose of describing the illustrative embodiments for the convenience of the reader and are not for the purpose of limitation thereof. Further, it should be understood that any one or more of the disclosed embodiments, expressions of embodiments, and examples can be combined with any one or more of the other disclosed embodiments, expressions of embodiments, and examples, without limitation. Thus, the combination of an element disclosed in one embodiment and an element disclosed in another embodiment is considered to be within the scope of the present disclosure and appended claims.

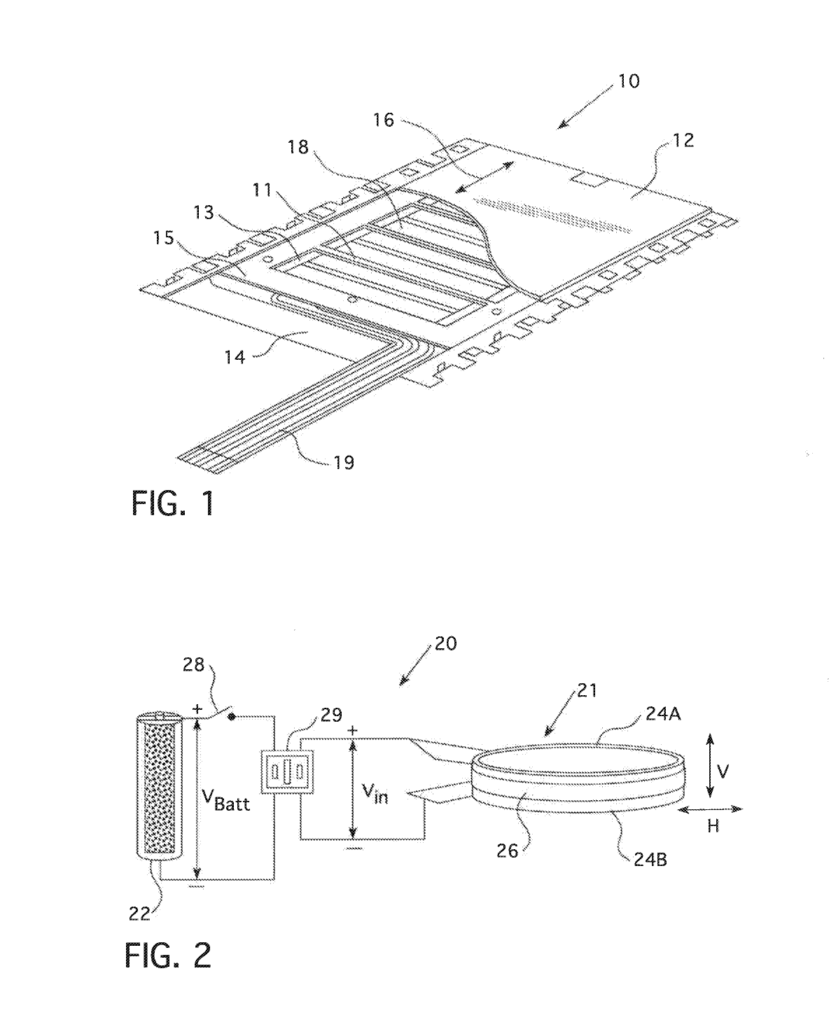

The present disclosure provides various embodiments of Electroactive Polymer Artificial Muscles (EPAM™) based integrated haptic feedback devices. Before launching into a description of various integrated devices comprising EPAM™ based haptic feedback modules, the present disclosure briefly turns to FIG. 1, which provides a cutaway view of a haptic system that may be integrally incorporated with hand held devices (e.g., mobile devices, gaming controllers, consoles, and the like) to enhance the user's vibratory feedback experience in a light weight compact module. Accordingly, one embodiment of a haptic system is now described with reference to the haptic module 10. A haptic actuator slides an output plate 12 (e.g., sliding surface) relative to a fixed plate 14 (e.g., fixed surface) when energized by a high voltage. The plates 12, 14 are separated by steel balls, and have features that constrain movement to the desired direction, limit travel, and withstand drop tests. For integration into a mobile device, the top plate 12 may be attached to an inertial mass such as the battery or the touch surface, screen, or display of the mobile device. In the embodiment illustrated in FIG. 1, the top plate 12 of the haptic module 10 is comprised of a sliding surface that mounts to an inertial mass or back of a touch surface that can move bi-directionally as indicated by arrow 16. Between the output plate 12 and the fixed plate 14, the haptic module 10 comprises at least one electrode 18, optionally, at least one divider 11, and at least one portion or bar 13 that attaches to the sliding surface, e.g., the top plate 12. Frame and divider segments 15 attach to a fixed surface, e.g., the bottom plate 14. The haptic module 10 may comprise any number of bars 13 configured into arrays to amplify the motion of the sliding surface. The haptic module 10 may be coupled to the drive electronics of an actuator controller circuit via a flex cable 19.

Advantages of the EPAM™ based haptic module 10 include providing force feedback vibrations to the user that are more realistic feelings, can be felt substantially immediately, consume significantly less battery life, and are suited for customizable design and performance options. The haptic module 10 is representative of actuator modules developed by Artificial Muscle Inc. (AMI), of Sunnyvale, Calif.

Still with reference to FIG. 1, many of the design variables of the haptic module 10, (e.g., thickness, footprint) may be fixed by the needs of module integrators while other variables (e.g., number of dielectric layers, operating voltage) may be constrained by cost. Since actuator geometry the allocation of footprint to rigid supporting structure versus active dielectric—does not impact cost much, it is a reasonable way to tailor performance of the haptic module 10 to an application where the haptic module 10 is integrated with a mobile device.

Computer implemented modeling techniques can be employed to gauge the merits of different actuator geometries, such as: (1) Mechanics of the Handset/User System; (2) Actuator Performance; and (3) User Sensation. Together, these three components provide a computer-implemented process for estimating the haptic capability of candidate designs and using the estimated haptic capability data to select a haptic design suitable for mass production. The model predicts the capability for two kinds of effects: long effects (gaming and music), and short effects (key clicks). “Capability” is defined herein as the maximum sensation a module can produce in service. Such computer-implemented processes for estimating the haptic capability of candidate designs are described in more detail in commonly assigned International PCT Patent Application No. PCT/US2011/000289, filed Feb. 15, 2011, entitled “HAPTIC APPARATUS AND TECHNIQUES FOR QUANTIFYING CAPABILITY THEREOF,” the entire disclosure of which is hereby incorporated by reference.

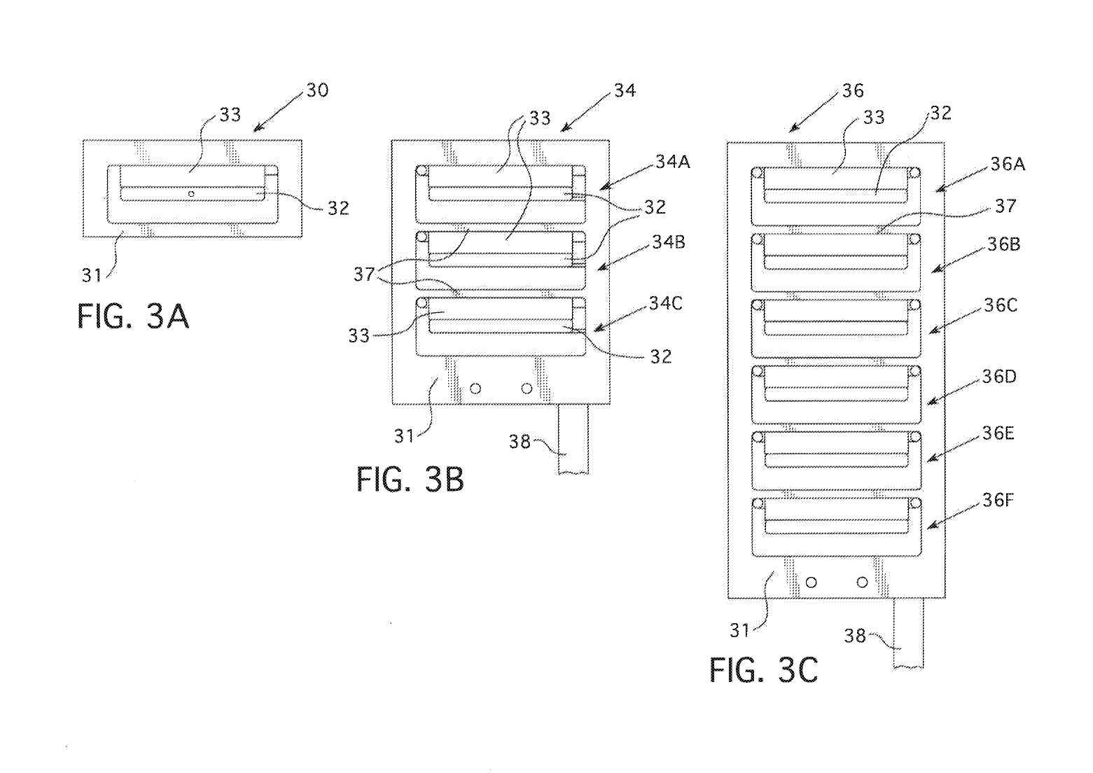

FIG. 2 is a schematic diagram of one embodiment of an actuator system 20 to illustrate the principle of operation. The actuator system 20 comprises a power source 22, shown as a low voltage direct current (DC) battery, electrically coupled to an actuator module 21. The actuator module 21 comprises a thin elastomeric dielectric 26 disposed (e.g., sandwiched) between two conductive electrodes 24A, 24B. In one embodiment, the conductive electrodes 24A, 24B are stretchable (e.g., conformable or compliant) and may be printed on the top and bottom portions of the elastomeric dielectric 26 using any suitable techniques, such as, for example screen printing. The actuator module 21 is activated by coupling the battery 22 to an actuator circuit 29 by closing a switch 28. The actuator circuit 29 converts the low DC voltage V_{Batt} into a high DC voltage Vᵢₙ suitable for driving the haptic module 21. When the high voltage Vᵢₙ is applied to the conductive electrodes 24A, 24B the elastomeric dielectric 26 contracts in the vertical direction (V) and expands in the horizontal direction (H) under electrostatic pressure. The contraction and expansion of the elastomeric dielectric 26 can be harnessed as motion. The amount of motion or displacement is proportional to the input voltage Vᵢₙ. The motion or displacement may be amplified by a suitable configuration of haptic actuators as described below in connection with FIGS. 3A, 3B, and 3C.

FIGS. 3A, 3B, 3B illustrate three possible configurations, among others, of actuator arrays 30, 34, 36, according to various embodiments. Various embodiments of actuator arrays may comprise any suitable number of bars depending on the application and physical spacing restrictions of the application. Additional bars provide additional displacement and therefore enhance the realistic feeling of force feedback vibration that the user can feel substantially immediately. The actuator arrays 30, 34, 36 may be coupled to the drive electronics of an actuator controller circuit via a flex cable 38.

FIG. 3A illustrates one embodiment of a one bar actuator array 30. The single bar haptic actuator array 30 comprises a fixed plate 31, an electrode 32, and an elastomeric dielectric 33 coupled to the fixed plate 31.

FIG. 3B illustrates one embodiment of a three bar actuator array 34 comprising three bars 34A, 34B, 34C coupled to a fixed frame 31, where each bar is separated by a divider 37. Each of the bars 34A-C comprises an electrode 32 and an elastomeric dielectric 33. The three bar haptic array 34 amplifies the motion of the sliding surface in comparison to the single bar actuator array 30 of FIG. 3A.

FIG. 3C illustrates one embodiment of a six bar actuator array 36 comprising six bars 36A, 36B, 36C, 36D, 36E, 36F coupled to a fixed frame 31, where each bar is separated by a divider 37. Each of the bars 34A-F comprises an electrode 32 and an elastomeric dielectric 33. The six bar actuator array 36 amplifies the motion of the sliding surface in comparison to the single bar actuator array 30 of FIG. 3A and the three bar actuator array 34 of FIG. 3B.

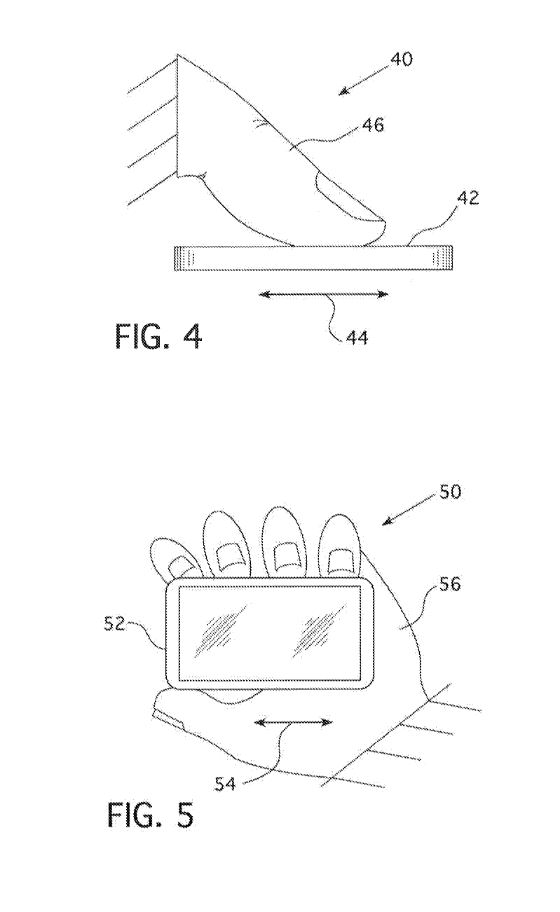

The actuator arrays 30, 34, 36 illustrated in reference to FIGS. 3A-3C may be integrated into a variety of devices in multiple applications to achieve desired effects. For example, in one embodiment, an actuator array may be adapted and configured into a moving touch surface sensor 40 as illustrated schematically in FIG. 4. In the embodiment shown in FIG. 4, an actuator array is integrated with a touch screen/LCD module 42 to implement a sliding actuator that moves the touch screen/LCD module 42 in plane in the direction indicated by the arrow 44. The motion feedback can be felt by finger 46.

In another example, an actuator array may be adapted and configured into a device effector 50 as illustrated schematically in FIG. 5. In the embodiment shown in FIG. 5, an actuator array is integrated with an inertial mass 52. The device effector 50 moves the inertial mass 52 in plane in the direction indicated by the arrow 54. The feedback force due to the motion of inertial mass 52 can be felt by the hand 54. This motion can be regular or periodic such as a vibration or it can have an arbitrary sequence of distance and acceleration to achieve specific haptic effects.

Various embodiments of moving touch surface sensors 40 and device effectors 50 as referenced in FIGS. 4 and 5 will be described in greater detail hereinbelow. Prior to turning to such detailed descriptions, however, the disclosure now turns to a description of a flexure suspension system, which may be employed in various embodiments of haptic systems subsequently described. The flexure suspension system simplifies the mechanical infrastructure required for implementation of the actuator arrays into a variety of devices according to the present disclosure.

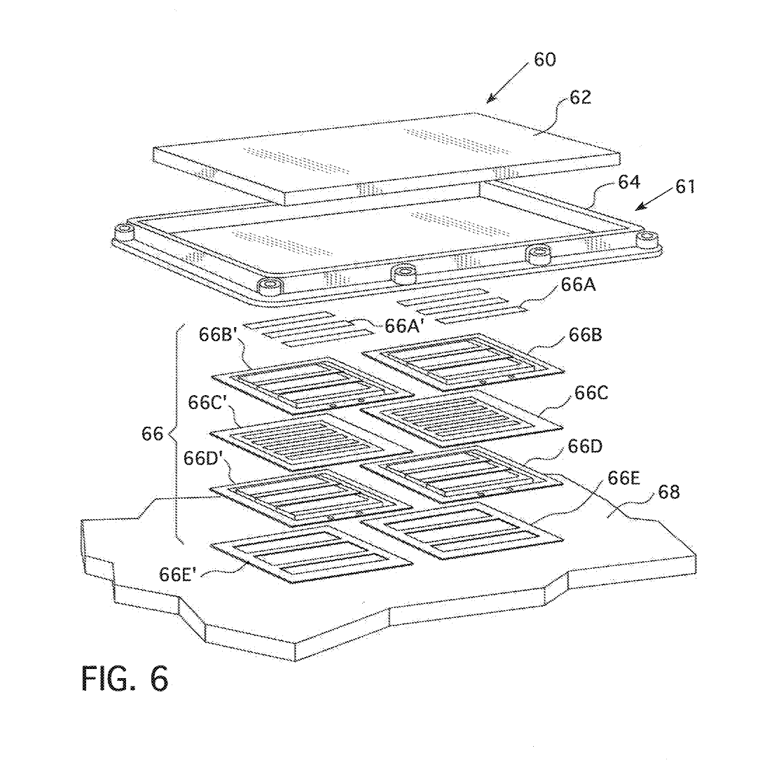

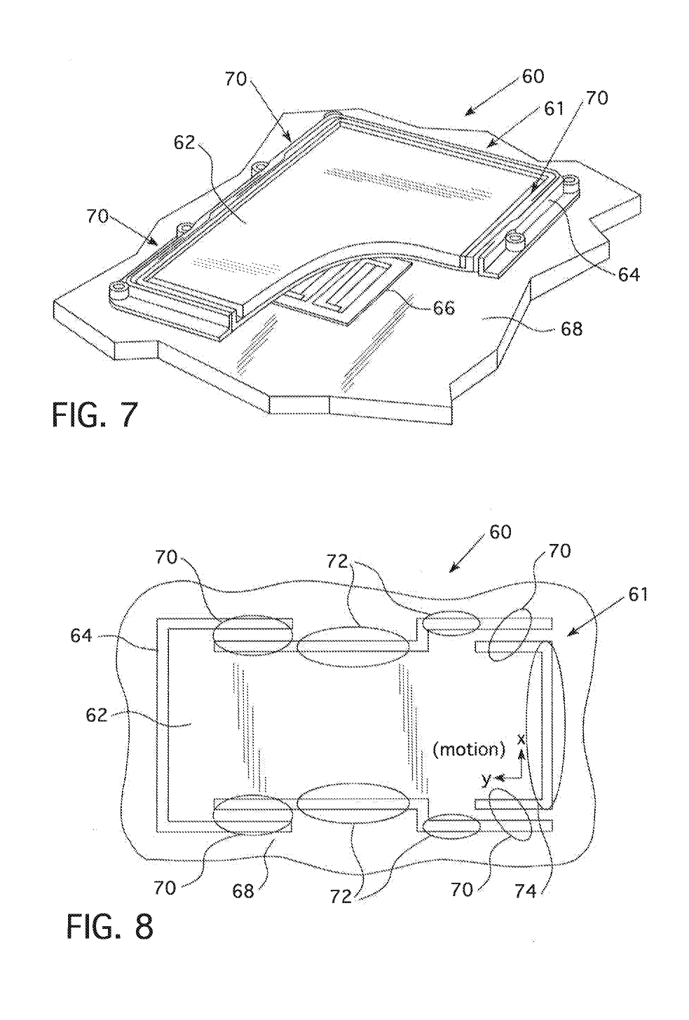

FIG. 6 is an exploded view of one embodiment of a haptic module 60 comprising a flexure suspension system 61 for a battery effector flexure tray 64. FIG. 7 is a partial cutaway view of the haptic module 60 comprising the flexure suspension system 61 shown in FIG. 6. With reference now to FIGS. 6 and 7, in one embodiment, the flexure tray 64 defines an opening for receiving a battery 62 therein. One side of the haptic actuator 66 (shown in exploded view format) is coupled to a bottom portion of the flexure tray 64 and the other side of the haptic actuator 66 is coupled to a mounting surface 68, which acts as a mechanical ground. In the embodiment shown in FIG. 6, the haptic actuator 66 comprises two sets of haptic actuator arrays. The first and second sets of haptic actuator arrays each comprise an output bar adhesive 66A, 66A′ to couple a first set of haptic actuator arrays 66B, 66B′ to the bottom of the flexure tray 64. Alternatively, this coupling may be mechanical. A frame-to-frame adhesive 66C, 66C′ is used to couple the first set of haptic actuator arrays 66B, 66B′ to a second set of haptic actuator arrays 66D, 66D′. A base frame adhesive 66E, 66E′ coupled the second set of haptic actuator arrays 66D, 66D′ to the mounting surface 68. As shown in FIG. 6, the haptic actuator 66 comprises dual three bar haptic actuator arrays. In other embodiments, as described hereinbelow, any suitable number of haptic actuator arrays comprising any suitable number of bars may be employed in battery effector flexure tray applications. Integration of the flexure suspension system 61 with the battery flexure tray 64 minimizes the need for additional suspension components and provides added resistance to shocks experienced during a drop or a drop test. Although not shown in FIG. 6, the battery 62 may be connected to a printed circuit board with a flex cable connector, for example.

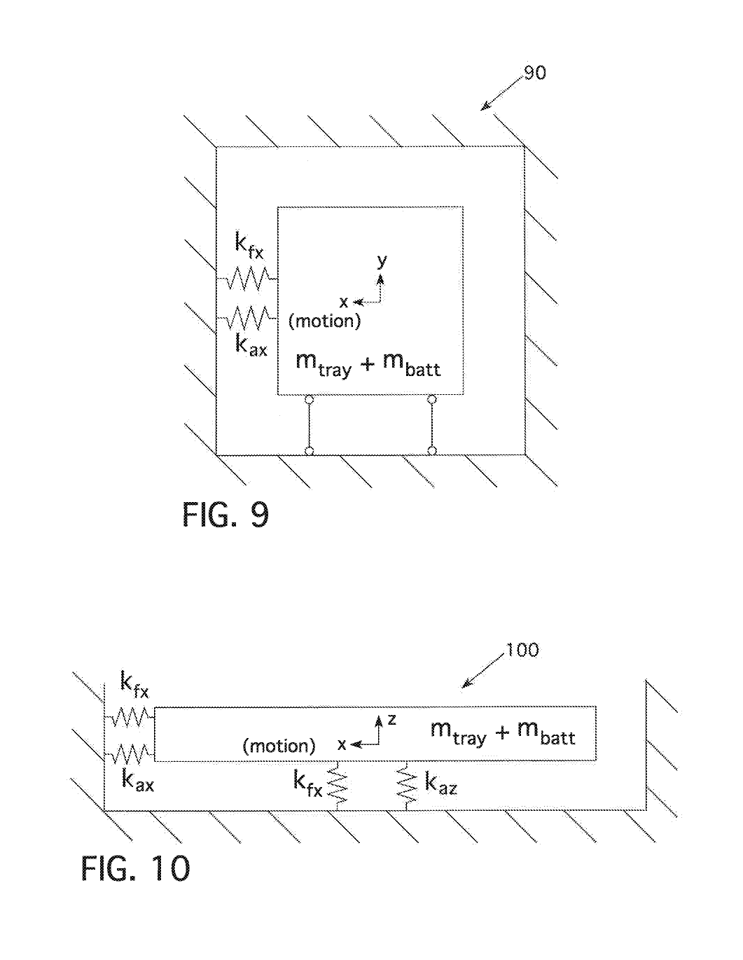

The flexure suspension system 61 can be used to suspend the battery 62, a touchscreen or any other mass or plate used for providing vibro-tactile stimulus to the user. One role of the flexure suspension system 61 is to provide stiffness in the directions other than the axis of haptic motion to maintain mechanical clearances between moving and stationary components, while at the same time providing as little resistance as possible in the haptic direction of motion so as to not impede haptic performance. The flexure suspension system 61 with the haptic actuator 66 mounted under the flexure tray 64 uses the combination of the tray mass and battery mass as an inertial mass, as discussed in more detail hereinbelow in reference to FIGS. 9 and 10. FIG. 7 also shows the flexures 70 provided in the flexure tray 64 to enable the haptic actuator 66 to move the flexure tray 64.

FIG. 8 is a schematic illustration of one embodiment of the haptic module 60 comprising the flexure suspension system 61 shown in FIGS. 6 and 7 comprising a flexure tray. The flexure tray 64 comprises flexures 70, travel stops 72, 74, and the battery 62 located within the opening defined by the flexure tray 64. The flexures 70 and travel stops 72, 74 can be molded into the flexure tray 64 or can be provided as separate components. As previously discussed, the flexure tray 64 is coupled to the mounting surface 68, which acts as a mechanical ground for the flexure suspension system 61. The flexures 70 located in one or more locations enable the flexure tray 64 to vibrate in one or more directions of motion. In the illustrated embodiment, the flexure tray 64 comprises four separate flexures 70 that enable the flexure tray 64 to move in the X and Y-directions. The flexure tray 64 also comprises X-travel stops 72 and Y-travel stops 74 to limit travel or movement in a predetermined direction and prevent damage from shock type movement. The X- and Y-travel stops 72, 74 are provided to constrain the motion of the flexure tray 64 in the X and Y-directions of motion, as discussed in more detail with reference to FIGS. 9 and 10 below, such that the flexure suspension system 61 can survive a sudden G-shock that may be experienced if the device integrated with the flexure suspension system 61 is dropped.

FIG. 9 illustrates an X and Y axes vibration motion diagram 90 for modeling the motion of the flexure suspension system 61 shown in FIGS. 6-8 in the X and Y-directions. FIG. 10 illustrates an X and Z axes vibration motion diagram 100 for modeling the motion of the flexure suspension system 60 shown in FIGS. 6-8 in the X and Z-directions. With reference now to FIGS. 6-10, k_{fx}=combined stiffness of the flexures 70 and electrical connections in the X-axis, kₐₓ=active stiffness of the haptic actuator 66 in the X-axis, k_{fz}=combined stiffness of the flexures 70 and electrical connection in the Z-axis, k_{az}=stiffness of the haptic actuator 66 in the Z-axis, m_{tray}+m_{batt}=total sprung mass consisting of the mass of the battery 62 and any other support structure in motion.

X-Axis Compliance

Compliance in the X-axis is one factor to consider when evaluating the performance of the flexure suspension system 60. Combined non-actuator stiffness (k_{fx}) should be reduced as much as possible and kept below about 10% of the actuator stiffness (kₐₓ), for example. Additional stiffness from electrical interconnects should be factored into the non-actuator stiffness calculations. Stiffness of the flexures 70 in the X-axis does not need to survive G-shock with proper use of the travel stops 72, 74.

Z-Axis Compliance

Compliance in the Z-axis should be reduced as much as possible to reduce deflection of the dynamic mass due to gravity or user input, and in particular, when the flexure suspension system 60 is integrated with a touch surface (e.g., touch screen or touch pad) suspension application where unrestricted X-axis movement of the assembly should be insured during user input. Ideally the total Z-axis stiffness can be over 300× the total X-axis stiffness. If negative Z-direction (−Z-direction) travel stops are not used, the flexure 70 should be configured to withstand force and shock that may be experienced during removal of the battery 62.

Y-Axis Compliance

With properly designed flexures 70, compliance in the Y-axis is relatively small as the flexure 70 beams are either in compression or tension. Any compliance in the Y-axis is the result of buckling or stretching of the flexure 70, which is undesirable in all situations. The amount of deflection in the Y-axis should be minimized to prevent damage to the flexures 70 during impact or shock, for example.

TABLE 1 below provides total flexure stiffness based on stiffness being less than 10% of total haptic actuator 66 stiffness, according to one embodiment, where the values provided are approximate example values.

TABLE 1
Total Flexure Stiffness (Stiffness <10% of total Haptic Actuator Stiffness)

| | | | | | |
|---|---|---|---|---|---|
| Sprung Mass (m_{batt} + m_{tray}) in g | 12.5 | 25 | — | 125 | 150 |
| 3-Bar Actuator Layers | 2 | 4 | — | | |
| Total Actuator Stiffness (kₐₓ) in N/m | 2.8 k | 5.6 k | | 28 k | 30.8 k |
| Total Flexure X-Stiffness Allowance | 125 | 250 | | 1250 | 1375 |
| (k_{fx}) in N/m | | | | | |

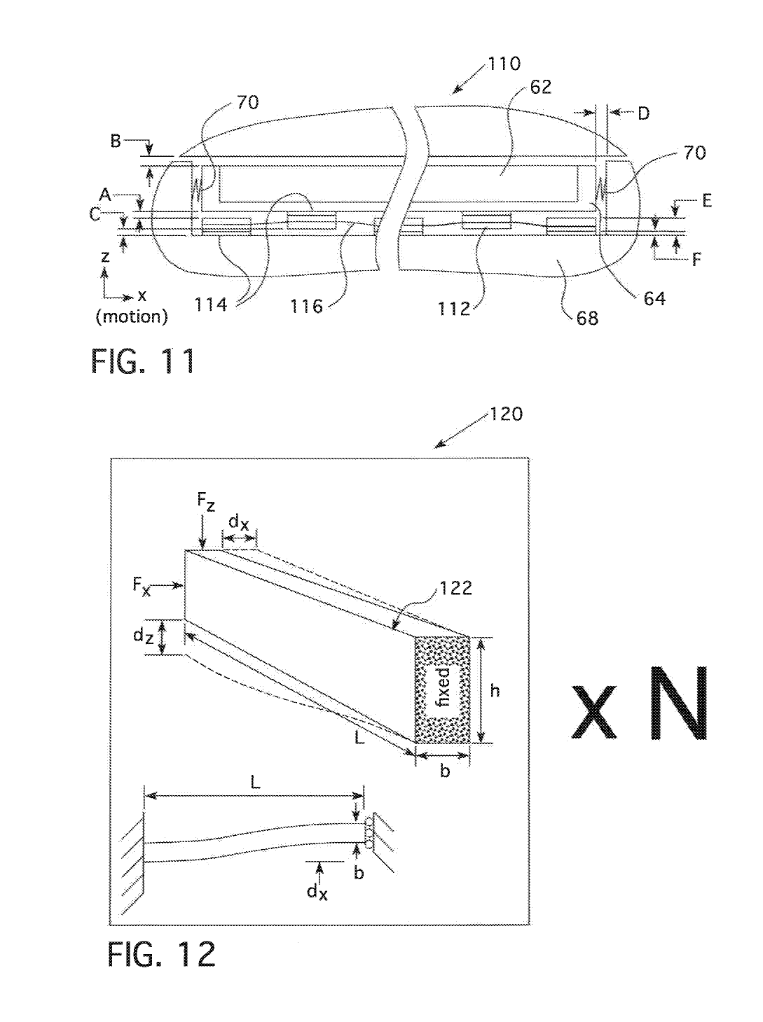

FIG. 11 is a schematic diagram 110 illustrating the flexure tray 64 travel stop 72, 74 features of the flexure suspension system 60 shown in FIGS. 6-8, according to one embodiment. In the flexure suspension system 60 illustrated in FIG. 11, an electroactive polymer layer 116 is distributed through a plurality of screen printed haptic actuator output bars or dividers 112 that are alternately attached to the mounting surface 68 of a device and the base of the flexure tray 64 by an adhesive 114. The flexure 70 is represented symbolically for convenience and clarity. In one embodiment, the stops 72, 74 are provided where possible while allowing free movement of the dynamic mass under normal loads. The travel stops 72, 74 prevent over extension and damage to the flexures 70 and the haptic actuator 66. The embodiment of the flexure 70 presented herein lends itself well to built-in travel stops 72, 74 in all axes except for the −Z-direction where pulling of the battery 62 out of the flexure tray 64 may cause damage. A positive Z-direction (+Z-direction) stop may be implemented using the actuator frame itself, which may be suitable to survive industry standard drop testing up to 1.5 m, for example.

TABLE 2 below provides flexure tray stop 72, 74 clearances, according to one embodiment. The clearances labeled A-F in TABLE 2 below are approximate example values and correspond to similarly labeled clearances in FIG. 11.

TABLE 2
Flexure Tray Stop Clearances

| Dimension | Minimum | Typical | | Maximum |
|---|---|---|---|---|
| A | 0.1 mm | 0.25 | mm | 0.5 mm |
| B | 0.1 mm | 0.25 | mm | 1.0 mm |
| C | 0.1 mm | 0.25 | mm | 0.29 mm |
| D | 0.2 mm | 0.5 | mm | 1.0 mm |
| E | | 0.4/0.6 | mm | |
| F | | 0.13 | mm | |

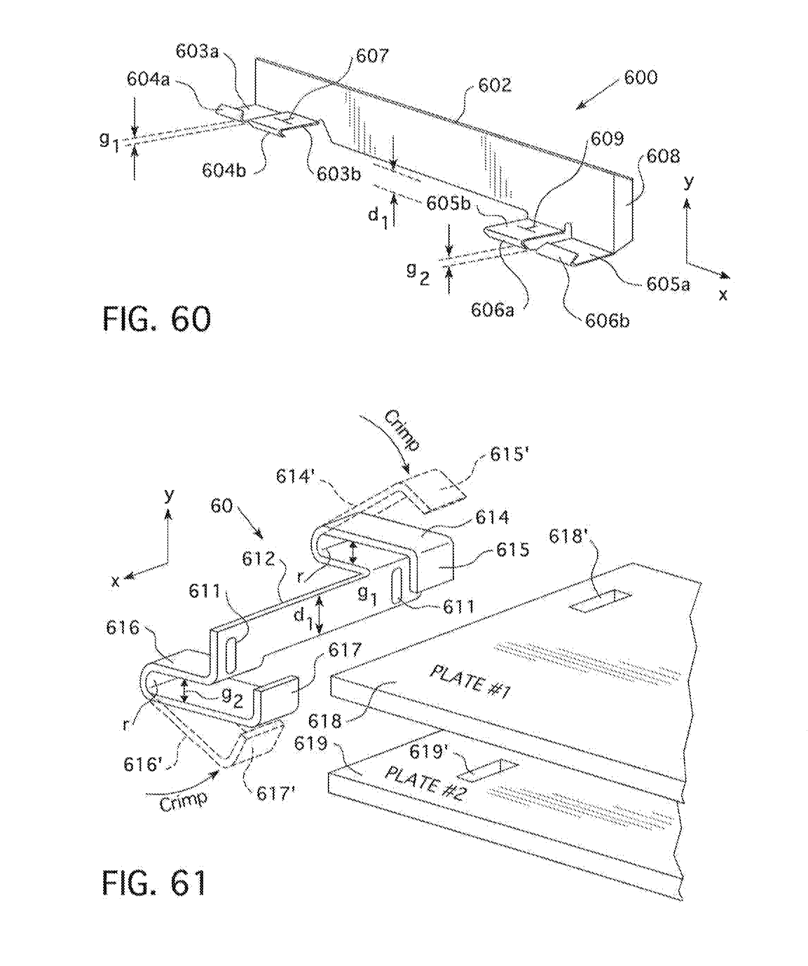

FIG. 12 is a schematic diagram 120 of a flexure linkage 122 beam model, according to one embodiment. The flexure linkages 122 can be made from a number of materials. In one embodiment, the flexure linkages 122 may be made of plastic using an injection molded set of linkages built into the handset back-shell or a tablet battery mount frame, for example. In such embodiments, the flexure linkage material may be made of a moldable plastic such as acrylonitrile butadiene styrene (“ABS”), for example, without limitation. Applications involving larger Z-direction loads and/or having limited space, flexure linkages 122 may be made of sheet metal and can be molded into a plastic frame. Alternatively, an entire stamped sheet metal subassembly can be made and used in applications that require the larger Z-direction loads. Embodiments of sheet metal stamped flexures are disclosed hereinbelow in connection with FIGS. 60-70. The stiffness of an individual linkage 122 can be calculated using the beam model shown in FIG. 12, for example, where the deflection of the flexure linkage 122 in the X- and Z-directions (dₓ and d_{z}) under corresponding forces (Fₓ and F_{z}) is modeled.

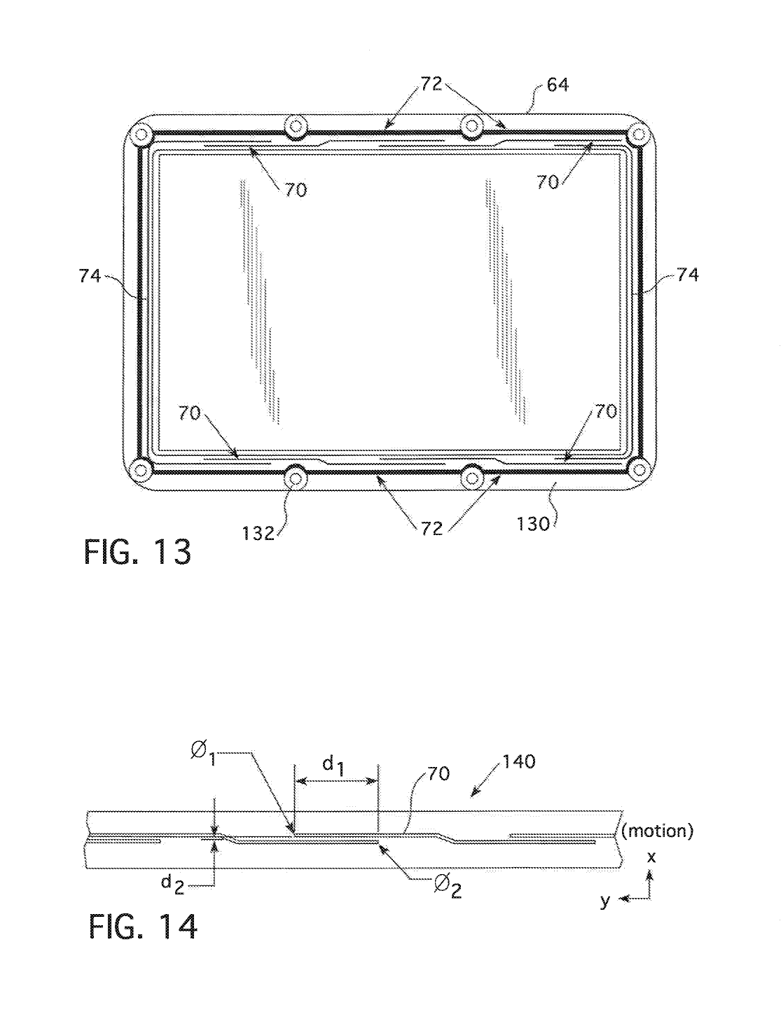

FIG. 13 illustrates one embodiment of a flexure tray 64 without a battery. The flexure tray 64 comprises a rigid outer frame 130 that is fixedly mounted to a mounting surface. In the illustrated embodiment, the rigid outer frame 130 may be fixedly mounted to the mounting surface by way of fasteners inserted through one or more apertures 132. Preferred fasteners include screws, bolts, rivets, and the like. As shown in FIG. 13, the flexure tray 64 comprises flexures 70 that enable the flexure tray 64 to move in the X and Y-direction to provide a vibro-tactile stimulus of the user. Also shown are the X-travel stops 72 and Y-travel stops 74 to prevent over extension and damage to the flexures 70 and haptic actuator.

FIG. 14 illustrates a segment 140 of one embodiment of the flexure tray 64. The segment 140 shows the diameters φ₁ and φ₂ of the flexure 70 as well as the overlapping distance d₁ between two flexure segments and the distance d₂ between bent segments of the flexure 70. TABLE 3 provides reference design flexure parameters, according to one embodiment, where the values provided are approximate example values.

TABLE 3
Reference Design Flexure Parameters

| | P430 ABS Plus (3D printed | |
|---|---|---|
| Material | FDM process) | |
| Actuator | 8 | L 3-Bar |
| Sprung Mass (m_{batt} + m_{tray}) | 60 | g |
| L = | 15 | mm |
| b = | 0.3 | mm |
| h = | 5 | mm |
| kₓ = | 92 | N/m |
| N = | 6 | |
| k_{fx(total)} | 552 | N/m |
| k_{tz} = | 153.3 | k N/m |

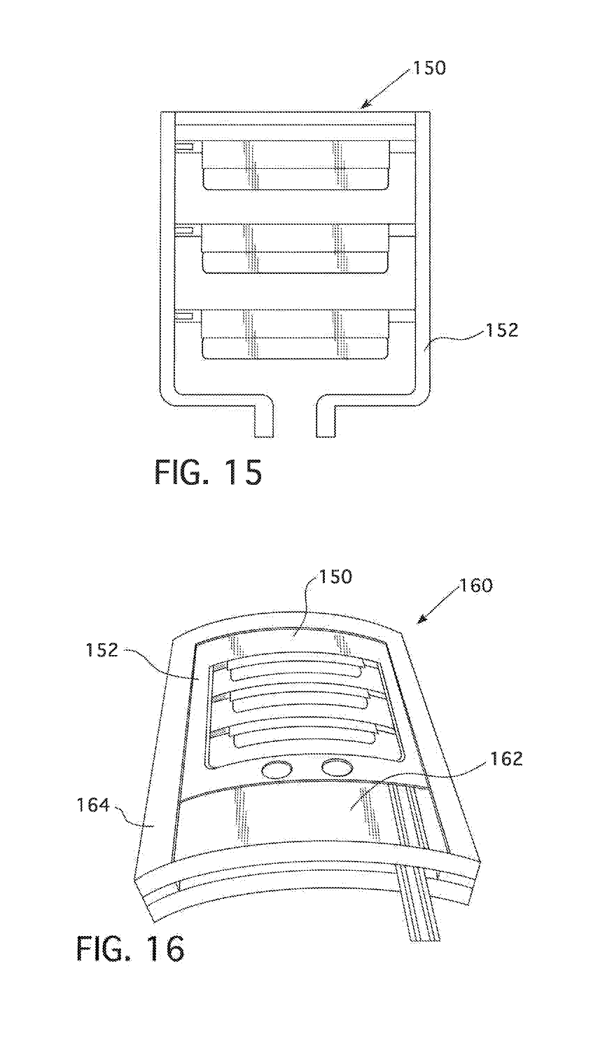

FIG. 15 illustrates one embodiment of a haptic actuator tape module 150 formed on a flexible film 152 rather a fixed rigid frame. In one embodiment, the haptic actuator tape module 150 comprises the actuator array elements as described in connection with FIGS. 1 and 3A-C without the fixed plate 14 rigid frame element such as the haptic module 10 shown in FIG. 1. By eliminating the fixed plate rigid frame, the flexible haptic actuator tape module 150 has an overall reduced thickness as compared with the rigid frame haptic module. In applications, the haptic actuator tape module 150 can be mounted to rigid or stiff substrates to support the flexible film 152. In one embodiment, the flexible film 152 of the haptic actuator tape module 150 may be a single or double sided adhesive tape, for example, for easy mounting to rigid substrates.

FIG. 16 illustrates one embodiment of the haptic actuator tape module 150 mounted on a curved surface 162 of a rigid/stiff substrate 164. As shown, the haptic actuator tape module 150 employs the stiffness of the substrate 164 to support the film 152. Various embodiments of haptic modules integrated with mobile devices that employ embodiments of the flexible haptic actuator tape module 150 are described hereinbelow.

FIGS. 17-19 illustrate one embodiment of a flexure tray 64 for a battery effector of a mobile device. FIG. 17 is a top view of a flexure tray 64 with an empty battery compartment 172 defined by an opening, the flexures 70, and a flex cable 174 portion of a haptic module 188 protruding from a bottom portion of the flexure tray 64. The haptic module 188 is electrically coupled to actuator controller circuit via the flex cable 174. Battery contacts 176 protruding in the interior portion of the battery compartment 172 couple the battery 62 to the main circuit of the mobile device. When the battery 62 is inserted in the battery compartment 172, the battery 62 terminals make an electrical connection with the battery contacts 176 in the tray 64.

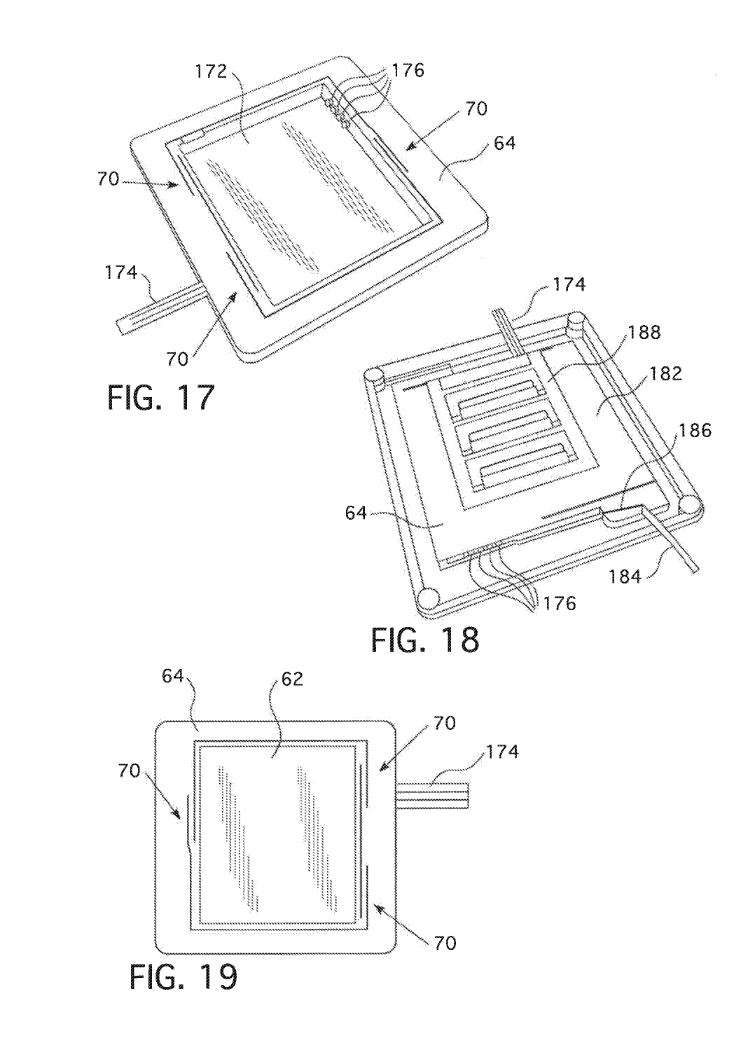

FIG. 18 is a bottom view of the flexure tray 64 with a haptic module 188 fixedly coupled to a bottom portion 182 of the flexure tray 64. A battery flex cable connector 184 is coupled to the battery contacts 176 inside the flexure tray 64. In one embodiment, the battery contacts 176 may be referred to as electrical spring connectors, embodiments of which are described in more detail hereinbelow. The battery flex cable connector 184 is routed through a slot 186 formed in the flexure tray 64. In various embodiments, the haptic module 188 may be the haptic actuator tape module 150 shown in FIGS. 15 and 16, the haptic module 10 shown in FIG. 1, or other suitable haptic modules consistent with the present disclosure. Although a three bar haptic module 188 is shown, any suitable haptic module with a fewer or a greater number of bars may be employed, without limitation. The shape of the active regions should be understood as not being limited to rectangular bars but could have any of a variety of geometries.

FIG. 19 is a top view of the flexure tray 64 with the battery 62 located in the battery compartment 172. The integrated flexure tray 64, battery 62, and haptic module 188 form a battery effector system to provide vibro-tactile feedback, which employs the battery 62 as an inertial mass.

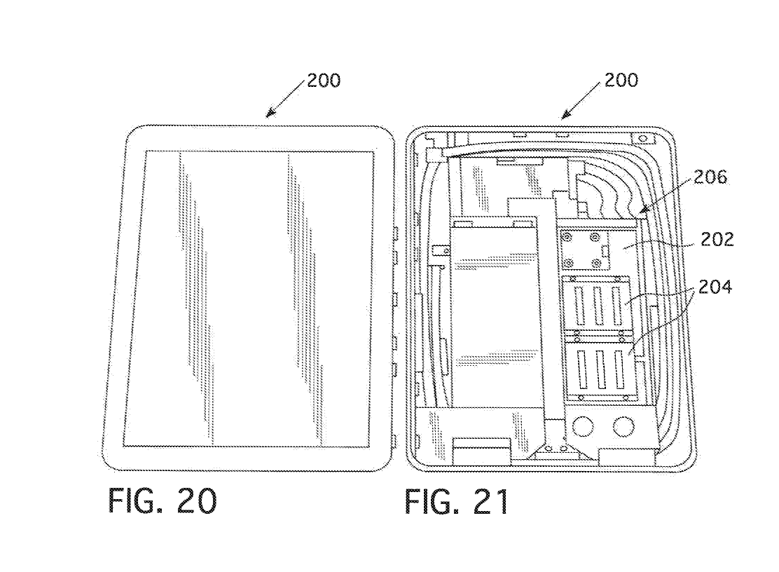

FIGS. 20 and 21 illustrate one embodiment of a tablet computer 200 integrated with at least one haptic actuator tape module 204. FIG. 20 is a top view of the tablet computer 200 and FIG. 21 is a bottom view of the tablet computer 200 with the rear cover removed to expose the battery compartment 206. In the embodiment illustrated in FIGS. 20-21, two haptic modules 204 are mounted to the tablet computer 200 battery, which acts as an inertial mass of the device effector. An actuator controller 202 is electrically coupled to the two haptic modules 204 to drive the haptic modules 204 as previously described in connection with FIG. 2. In various embodiments, the haptic module(s) 204 may be the haptic actuator tape module 150 shown in FIGS. 15 and 16, the haptic module 10 shown in FIG. 1, or other suitable haptic modules consistent with the present disclosure. As shown, the haptic modules 204 include three bars. In other embodiments, however, the haptic modules 204 may include a greater or a fewer number bars, without limitation.

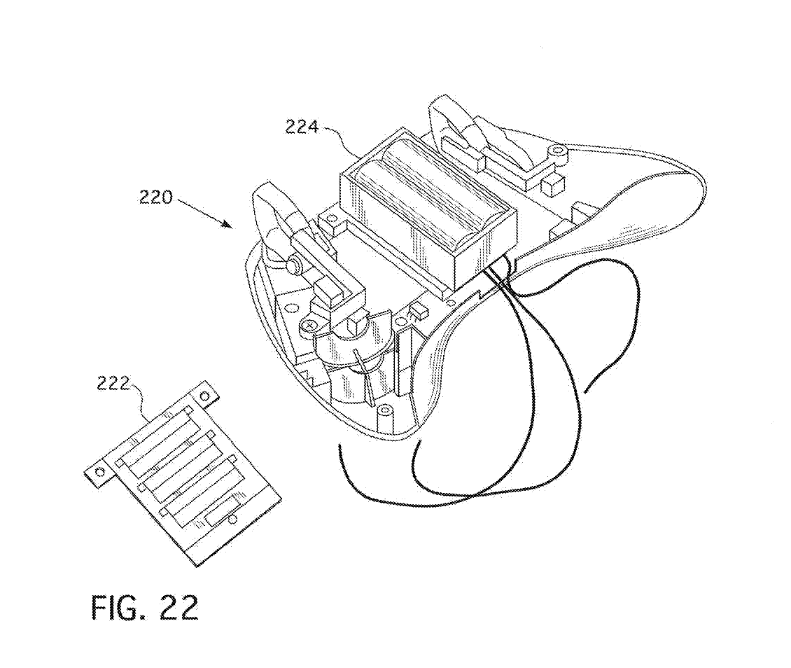

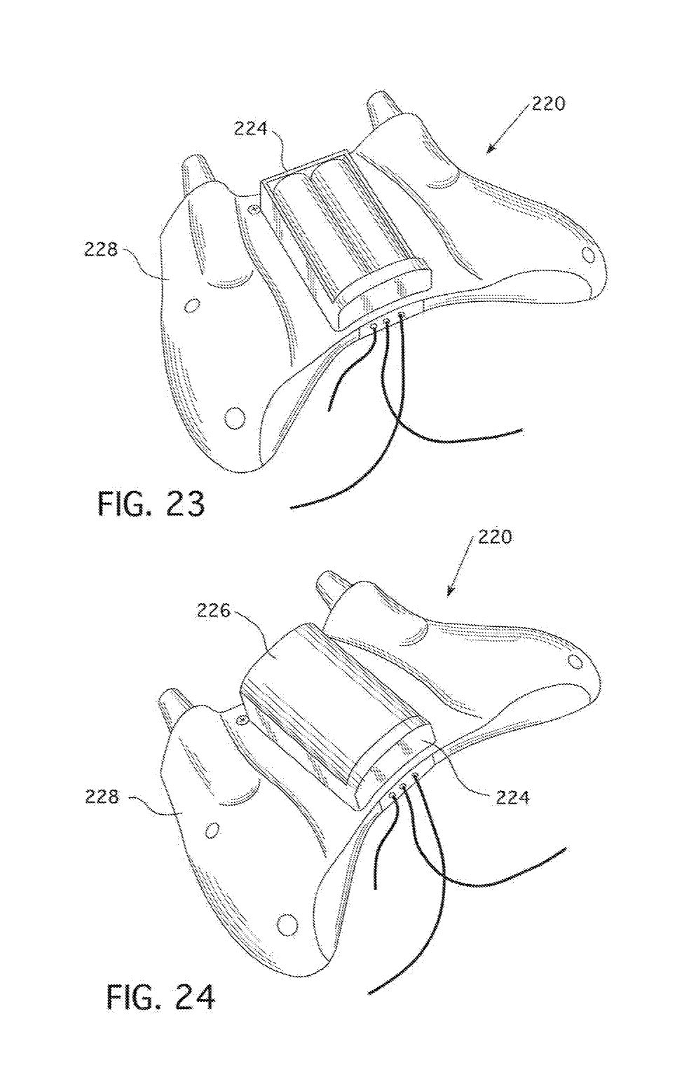

FIGS. 22-24 illustrate a gaming controller 220 mechanically integrated with one embodiment of a haptic module 222. The haptic module 222 is configured to mount to an interior portion of a battery cover 226, which is located over a battery pack 224 located under the gaming controller 220. In FIG. 22, the gaming controller 220 has both the battery pack 224 cover 226 and the back cover 228 of the gaming controller 220 removed. FIG. 23 illustrates the gaming controller 220 with the back cover 228 reinstalled. FIG. 24 illustrates the gaming controller 220 with the back cover 228 and the battery pack 224 cover 226 reinstalled. The battery pack 226 comprises a movable effector tray (not shown) with travel stops in the battery pack 226 housing. In various embodiments, the haptic module 222 may be the haptic actuator tape module 150 shown in FIGS. 15 and 16, the haptic module 10 shown in FIG. 1, or other suitable haptic modules consistent with the present disclosure. As shown, the haptic modules 204 include three bars. In other embodiments, however, the haptic modules 204 may include a greater or a fewer number of bars, without limitation.

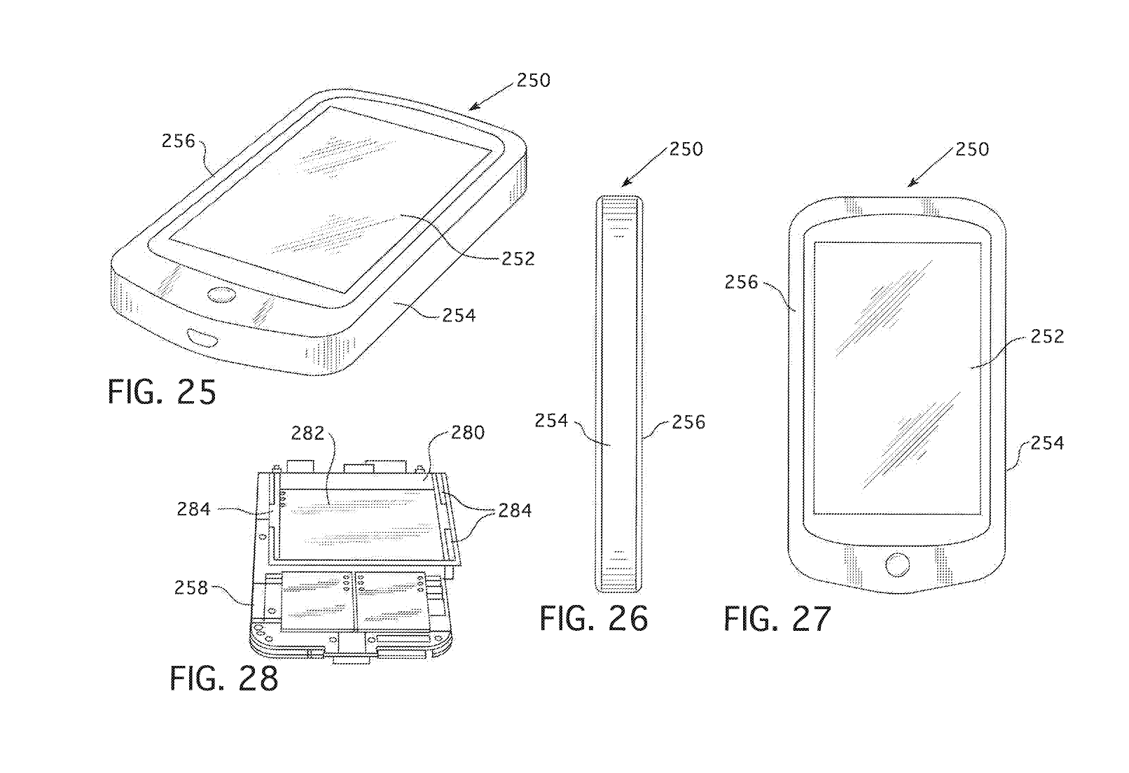

FIGS. 25-28 illustrate a mobile device integrated with a haptic module, according to various embodiments. FIG. 25 is a perspective view of a mobile device 250 integrated with a haptic module. FIG. 26 is a side view of the mobile device 250, and FIG. 27 is a top view of the mobile device 250. The mobile device 250 comprises a chassis 254 and a top plate 256. In one embodiment, the chassis 254 may be formed of machined aluminum, for example, or other suitable materials. In one embodiment, the top plate 256 may be formed of carbon fiber composite, for example, or other suitable materials, and in another embodiment, may be water jet cut carbon fiber composite. FIG. 28 is a back cover 258 of the mobile device 250. A flexure tray 280 battery effector, which may be similar to the flexure tray 64 battery effector described in connection with FIGS. 17-19, is integrated with the back cover 258 of the mobile device. Flexures 284 enable the flexure tray 280 to move under the influence of a haptic actuator coupled to a battery located in the battery compartment 282.

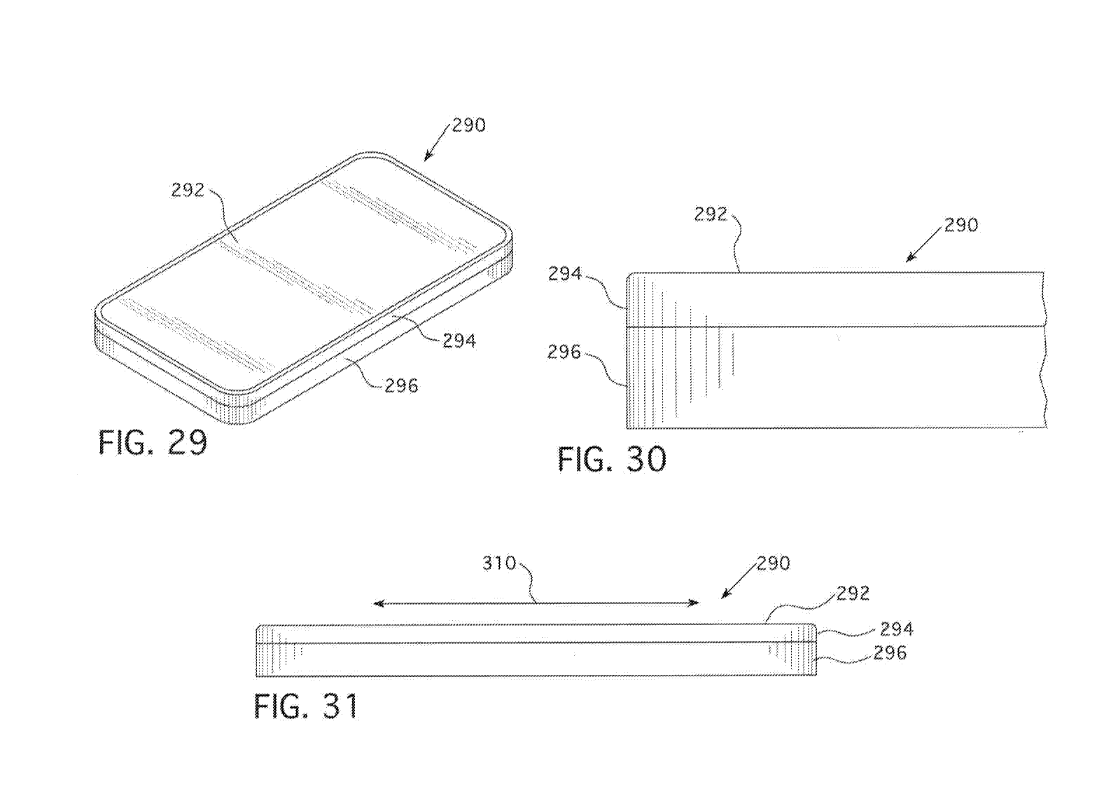

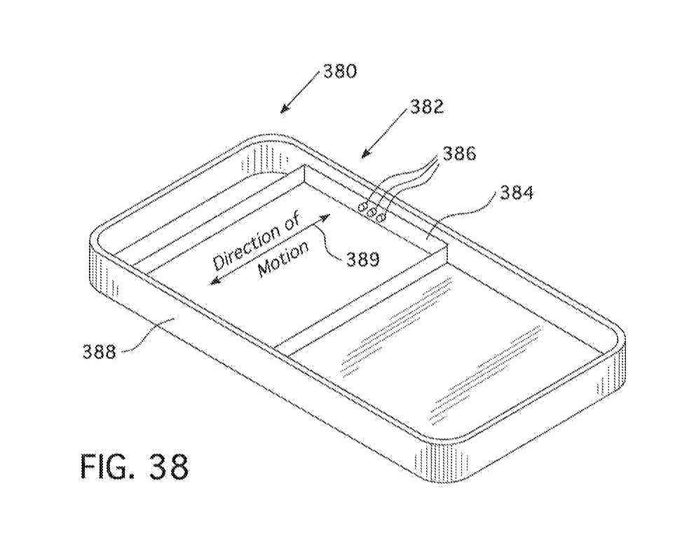

FIGS. 29-46 illustrate various embodiments of mobile devices integrated with haptic actuators and sliding mechanisms to move touch surfaces and vibrate batteries inside the mobile device. One of the challenges that is facing “moving surface” moving touch surfaces is sealing between the touch surface and the bezel of the mobile device. The other challenge is maintaining a bezel around the edge of the touch surface to provide stiffness to the touch surface screen and improve drop test survivability. FIGS. 29-37 illustrates one embodiment of a mobile device 290 comprising a touch surface 292 and two main subassemblies, a display subassembly 294 and a body subassembly 296. FIGS. 38-46 illustrate one embodiment of a battery effector 382 for a mobile device 380.

FIG. 29 is a perspective view of a mobile device 290 comprising a touch surface 292 and two main subassemblies, a display subassembly 294 and a body subassembly 296, according to one embodiment. FIG. 30 is a detail side view of the mobile device 290, according to one embodiment. FIG. 31 is a side view of the mobile device 290 illustrating the direction of motion of the touch surface 292. Referencing now FIGS. 29-31, it will be appreciated that the touch surface 292 may refer to a touch screen, touch pad, or other user interfaces that utilize a touch. The touch surface 292, the display subassembly 294, and the body subassembly 296 may be sealed in the same manner as conventional mobile devices. A haptic actuator located between the display subassembly 294 and the body subassembly 296 moves the touch screen 292 in the direction shown by the arrow 310. In various embodiments, the mobile device 290 also may comprise a display, a bezel, and other components such as a front facing camera, speakers, and the like. In various embodiments, the display subassembly 294 comprises a flex cable that connects the electronics components of the display subassembly 294 to the main circuit board in the body subassembly 296. In various embodiments, the body subassembly 296 comprises the main chassis, battery, main circuit board, camera, and the like. The body subassembly 296 chassis may also comprise a slot or cut-out that allows the flex cable to pass through the chassis and to the main circuit board in the body subassembly 296. The various components of the mobile device 290 will now be discussed in more detail.

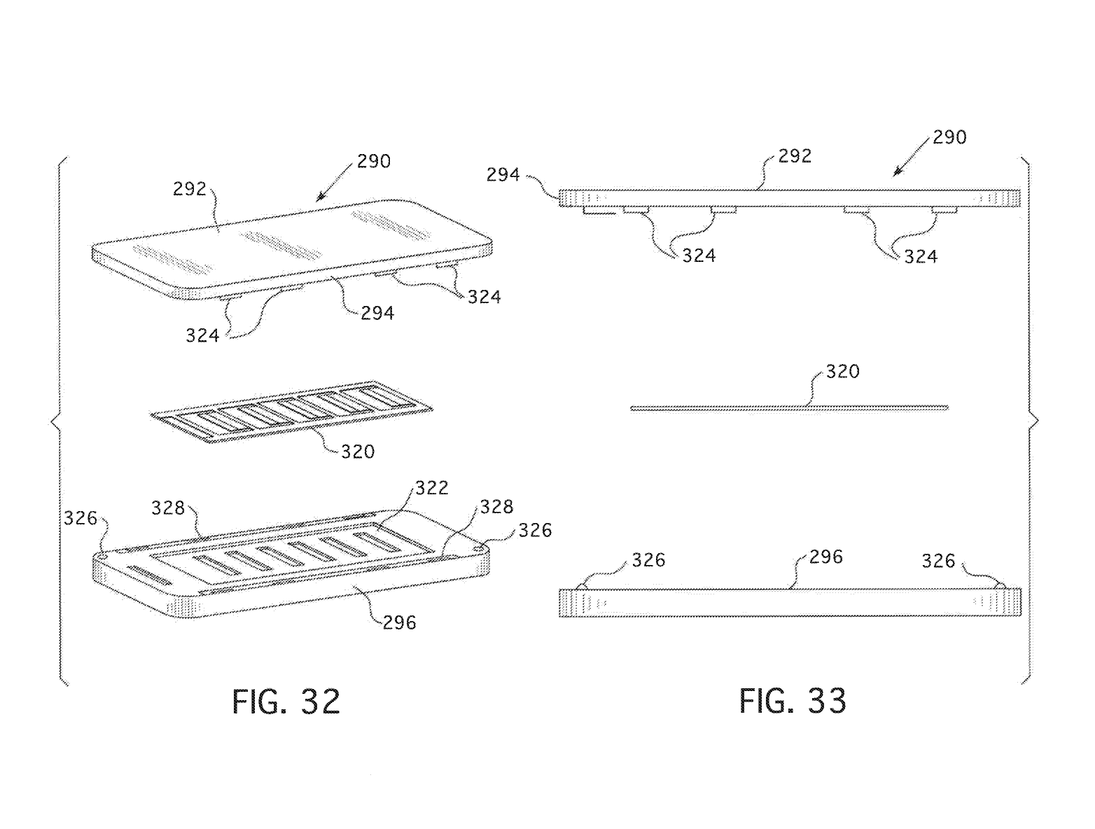

FIG. 32 is an exploded perspective view of one embodiment of the mobile device 290 and FIG. 33 is an exploded side view of the mobile device 290, according to one embodiment. In one embodiment, the mobile device 290 comprises a haptic actuator 320, as described hereinbefore in connection with FIGS. 1-3C, located between the display subassembly 294 and the body subassembly 296 to move the touch surface 292. The body subassembly 296 comprises a recessed compartment configured to receive the haptic actuator 320 therein. In the illustrated embodiment, the haptic actuator 320 comprises six bars. In other embodiments, however, the haptic actuator may comprise a fewer or a greater number of bars, without limitation. A sliding mechanism is used to move the touch surface 292. The sliding mechanism comprises slide rails 328 located in the body subassembly 296 and corresponding clips 324 that couple to the slide rails 328 located under the display subassembly 294 and to the touch surface 292. In the illustrated embodiment, the slide rails 328 are incorporated in the chassis of the body subassembly 296. In other embodiments, the slide rails 328 may be incorporated into the display subassembly 294, for example. Limit screws 326 provide mechanical hard stops in the X- and Y-direction to limit movement of the touch surface 292, for example, and for the purpose of surviving a drop test. A mechanical hard stop in the Z-direction may be provided by the sliding mechanism. X and Y limit set screws 326 provide clearance around the set screws 326 to allow limited movement and also support in the case of a drop test.

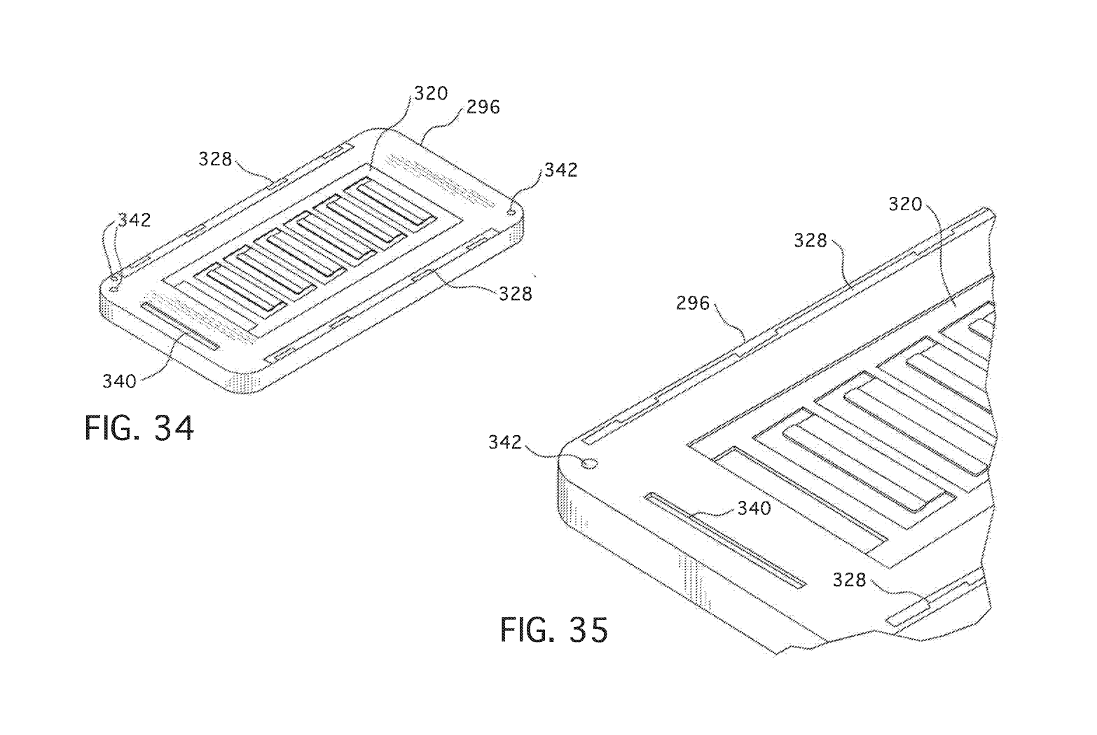

FIGS. 34-35 are detail views of the haptic actuator 320 integrated with the body subassembly 296 portion of the mobile device 290, according to one embodiment. FIG. 34 is a perspective view of the body subassembly 296 portion of the mobile device 290 with the haptic actuator 320 located therein, according to one embodiment. FIG. 35 is a magnified partial perspective view of the body subassembly 296 shown in FIG. 34, according to one embodiment. The haptic actuator 320 is located within the recessed compartment 322 (FIG. 32) of the body subassembly 296. The slide rails 328 are disposed on lateral sides of the body subassembly 296. A display flex pass through slot 340 is formed in the body subassembly 296 chassis to receive the flex cable, which electrically couples the electronic components in the display subassembly 294 with the main circuit board in the body subassembly 296. X-Y limit set screw apertures 342 are provided in the body subassembly 296 to receive the set screws 326 (FIGS. 32-33).

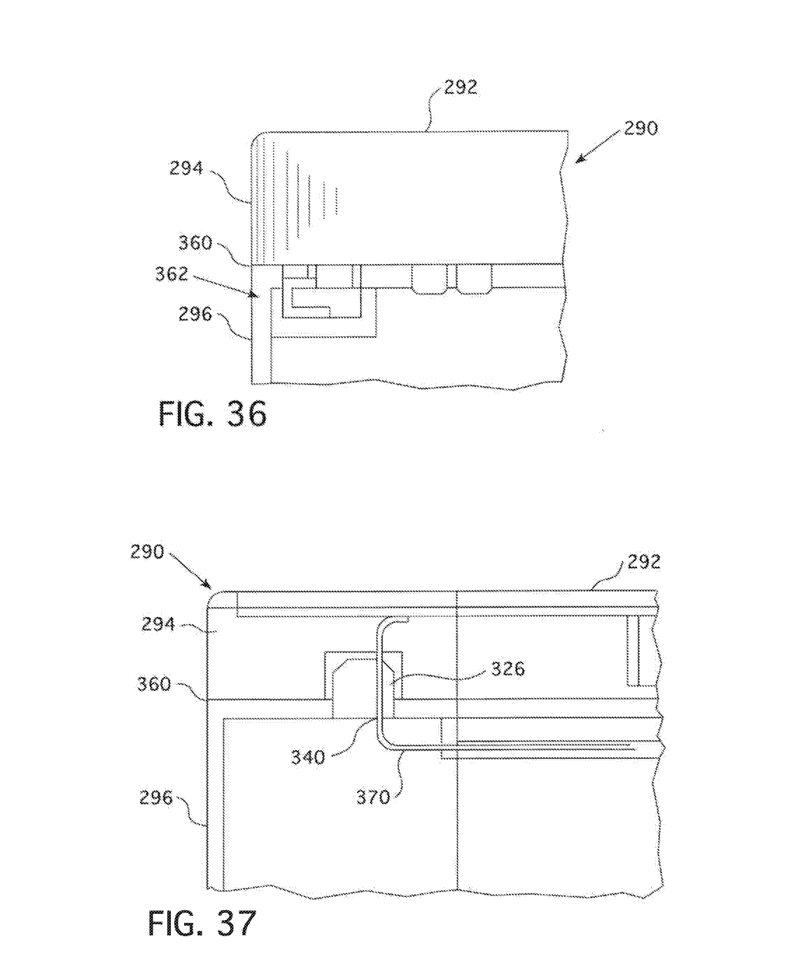

FIGS. 36-37 show details of the display subassembly 294 and the body subassembly 296. FIG. 36 is a partial see-through side view of the display subassembly 294 of the mobile device 290, according to one embodiment. FIG. 37 is a partial see-through side view of the display subassembly 294 of the mobile device 290, according to one embodiment. FIG. 36 shows the railing details of the sliding mechanism 362 and a clearance gap 360 between the display subassembly 294 and the body subassembly 296, which is controlled by the set screws 326 as shown in FIG. 37. Also shown in FIG. 37 is the pass through slot 340 and the flex cable 370 that electrically couples the display subassembly 294 electronic components with the main circuit body subassembly 296.

FIGS. 38-46 illustrate one embodiment of a battery effector 382 for a mobile device 380. FIG. 38 is a perspective view of a bottom housing 388 portion of a mobile device 380 comprising a battery effector 382, according to one embodiment. In one embodiment, the battery effector 382 comprises a tray 384, which comprises a battery connector 386. The battery effector 382 fits inside the housing 388 (e.g., chassis) portion of the mobile device 380. The embodiment of the mobile device 380 illustrated in FIGS. 38-46 utilizes a haptic actuator in conjunction with the sliding mechanism described in connection with FIGS. 29-37 (e.g., the slide rails and clips). The battery effector 382 motion is indicated by arrow 389. The battery acts as the inertial mass for battery effector 382. The battery tray 384 enables the user to easily replace the battery. The clearance between the battery tray 384 and the housing 388 allows free motion in the direction of arrow 389 while providing a mechanical hard stop for drop test purposes. A battery flex cable provides an electrical connection between the battery and the main circuit board of the mobile device 380 while allowing the battery tray 384 to move.

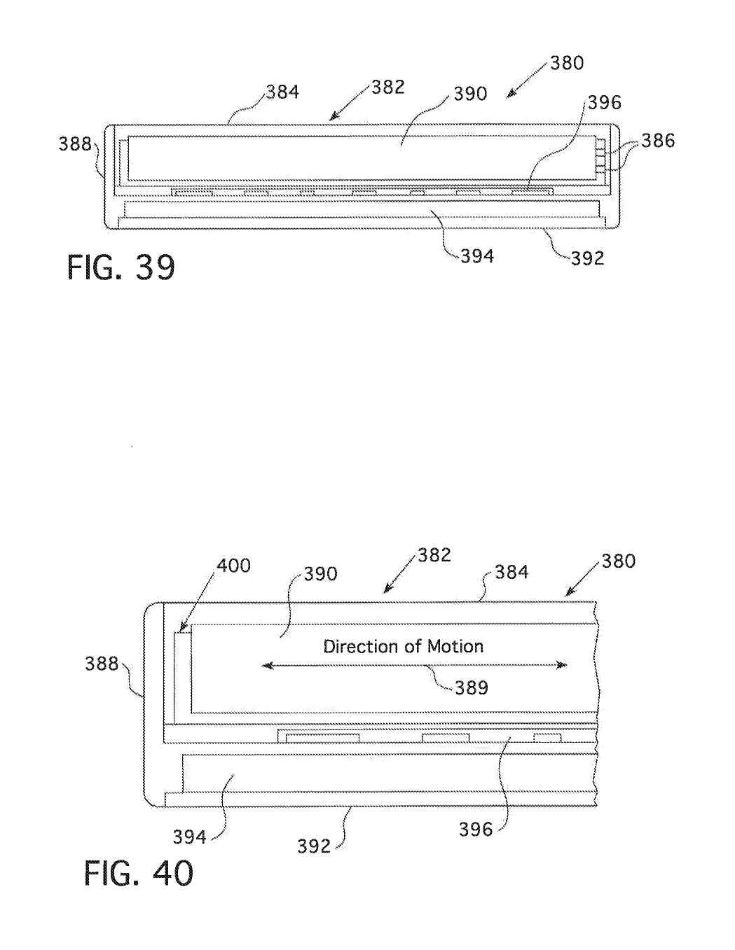

FIG. 39 is a sectional view of the mobile device 380 and FIG. 40 is a partial detail sectional side of the mobile device 380, according to one embodiment. The mobile device 380 comprises a battery 390, a touch surface 392, and a display 394. The battery tray 384 is located inside the housing 388 and a haptic actuator 396 is attached to the bottom of the battery tray 384. The haptic actuator 396 is located between the display 304 and the battery tray 384. The battery 390 is located inside the battery tray 384 and acts as an inertial mass when the tray 384 is moved in the direction of arrow 389. The battery 390 is electrically coupled to the battery connector 386.

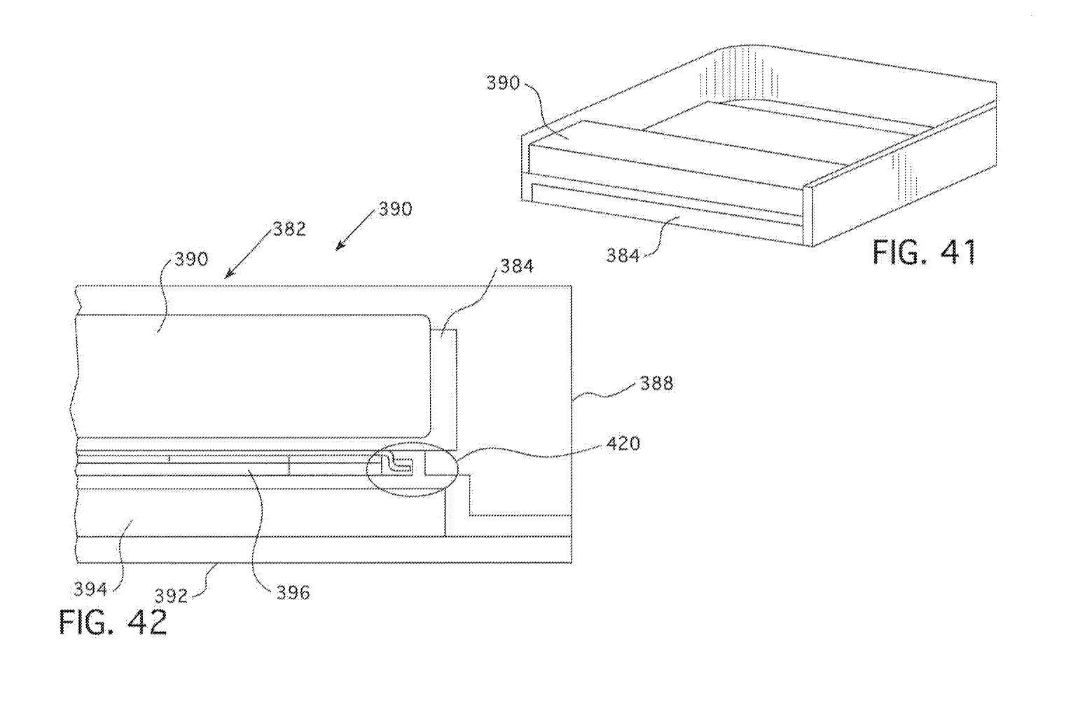

FIG. 41 is a perspective sectional view of the removable battery 390 and a battery tray 384 of the mobile device 380, according to one embodiment. FIG. 42 is a partial sectional view of the slide rails of a sliding mechanism 420 of the mobile device 380, according to one embodiment. The battery 390 is located within the battery tray 384 and one side of the haptic actuator 396 is fixedly coupled to the bottom of the battery tray 384. The display 394 is located on the other side of the haptic actuator 396. The touch surface 392 is coupled to the display 394.

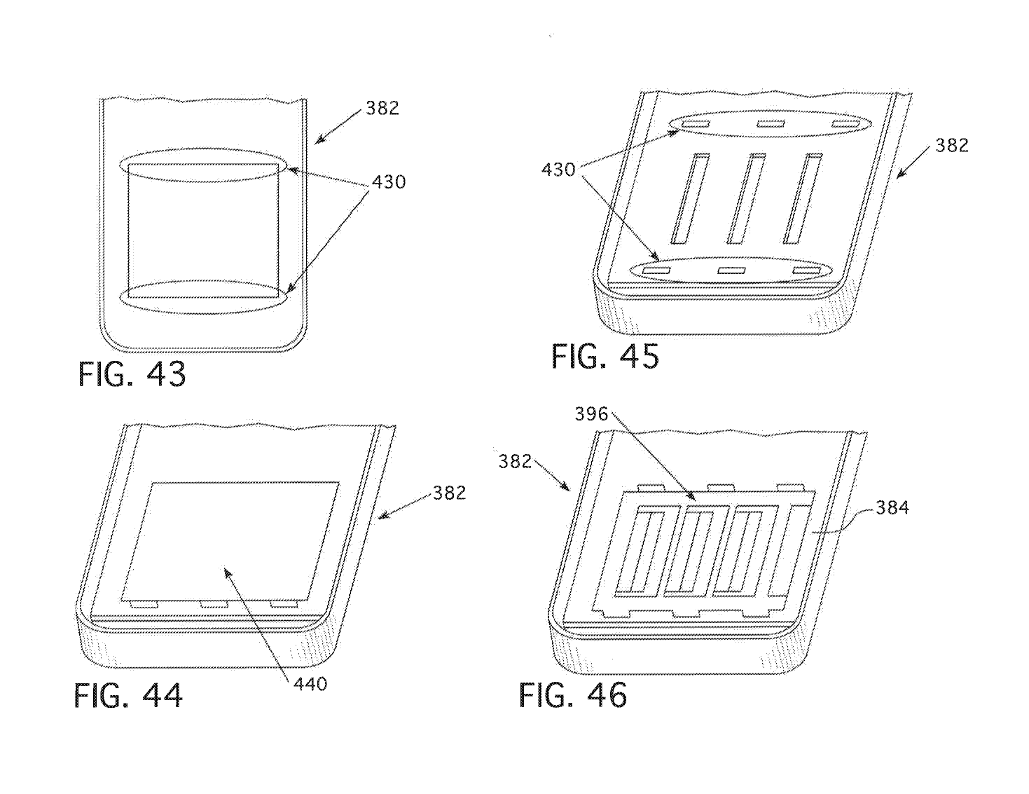

FIGS. 43-46 show various details of a battery effector 382, according to one embodiment. FIG. 43 is a top view of a battery effector 382 with an actuator moving plate 440, according to one embodiment. FIG. 44 is partial perspective view of the battery effector 382 with the actuator moving plate 440 and located above slide rails 430 as shown in FIGS. 43 and 45, according to one embodiment. FIG. 45 is a partial perspective view of the battery effector 382 showing the position and orientation of the slide rails 430, according to one embodiment. FIG. 46 is a partial perspective view of the battery effector 382 showing the haptic actuator 396 located within the battery tray 384, according to one embodiment. In various embodiments, the actuator moving plate 440 may be integrated with the battery tray 384 to provide a more compact device. The sliding rails 430 mechanism also provide support for limited motion of the battery tray 384.

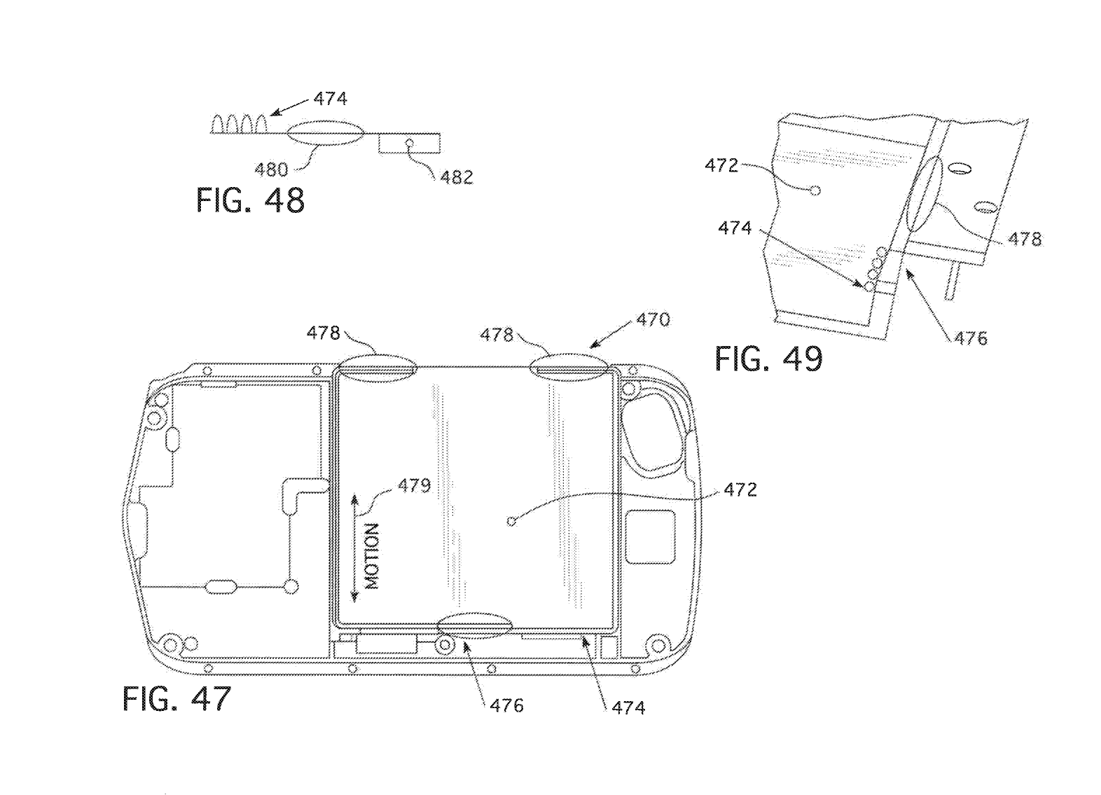

FIGS. 47-49 illustrate one embodiment of electrical battery connections for a mobile device integrated with one embodiment of a haptic module. FIG. 47 is a bottom view of one embodiment of a mobile device 470 integrated with a haptic module, according to one embodiment. The back cover of the mobile device 470 has been removed to show the battery tray 472, electrical spring connectors 474 for the battery, interconnect flex cable 476, and flexures 478 that allow the battery tray 472 to vibrate and/or provide vibro-tactile stimulus to the user. As previously discussed in connection with multiple embodiments, the battery tray 472 comprising the flexures 478 are coupled to a haptic actuator (not shown) to impart motion to the battery tray 472 in the direction indicted by arrow 479. The flexures 478 enable the motion and stops (not shown) are provided to limit the motion of the battery tray 472. The electrical spring connectors 474 for the battery are used to couple the battery to the electronic components in main circuit board and the display of the mobile device 478. The interconnect flex cable 476 is used to electrically couple the haptic actuator to an actuator circuit (not shown) to drive the haptic actuator. FIG. 48 is a detail view of the electrical spring connector 474 for the battery coupled to a flexible circuit area 480 and a grounded connection area 482, according to one embodiment. FIG. 49 is a partial cut away view of the mobile device 470 showing the battery tray 472, the electrical spring connectors 474, and the interconnect flex cable 476, according to one embodiment. Also shown is one of the flexures 478.

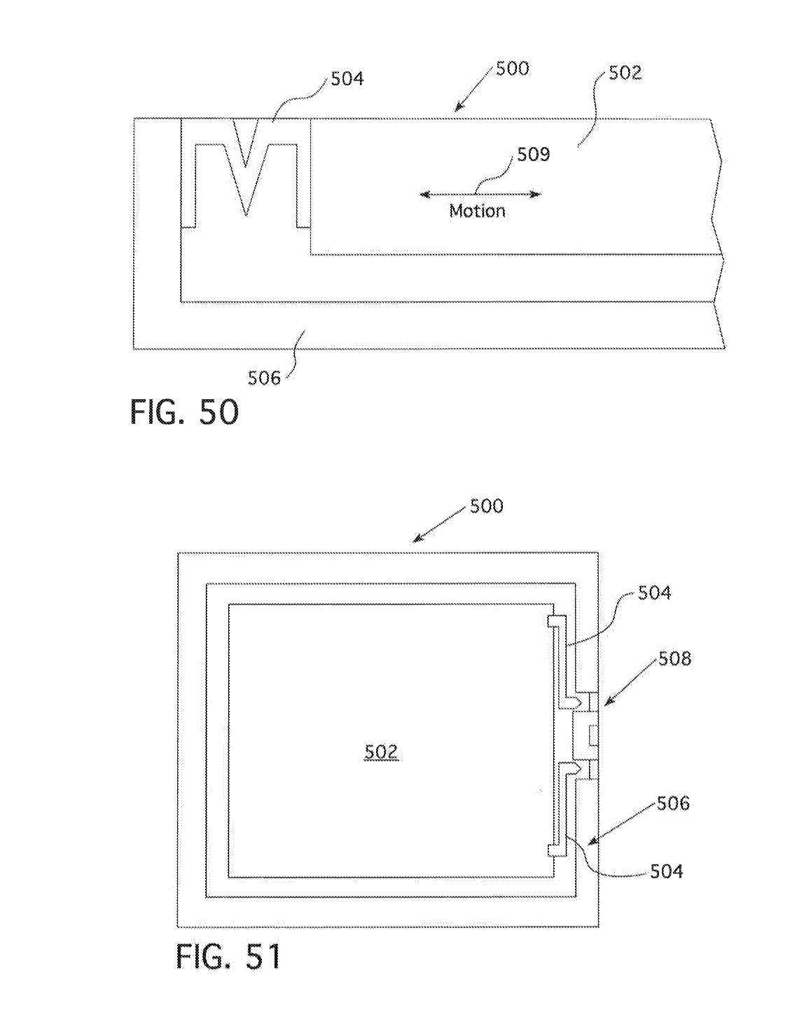

FIG. 50 is a sectional view of an integrated flexure-battery connection system 500 comprising a battery effector flexure utilizing a metal battery connector as a flexure, according to one embodiment. FIG. 51 is a top view of the integrated flexure-battery connection system 500 shown in FIG. 50. A housing 506 is configured to receive a battery 502 and to support a flexure suspension system 504, which acts both as a suspension system for the battery 502 and is electrically coupled to the electrical connection 508. A haptic module may be coupled to the battery 502 to provide vibro-tactile stimulus to the user. The battery 502 acts as the inertial mass for imparting motion. When the battery 502 is employed as an inertial mass for movement purposes, it is necessary to provide a suspension system, which is provided by the flexure suspension system 504. The embodiments shown in FIGS. 50-51 integrate the functionality of the electrical connections 508 for the battery 502 and the flexure suspension system 504. Accordingly, as shown in FIG. 50, in one embodiment, the electrical connection for the battery 502 comprises a flexure suspension system 504 that can be made of a metallic electrical conductor (e.g., brass, copper, gold, silver, stainless steel, and the like) with suitable mechanical properties and is able to electrically conduct to enable an adequate electrical coupling to the electrical connection 508 of the battery 502. As shown in FIG. 50, the flexure suspension system 504 comprises a flexure element having a cross-section resembling an “M” to provide spring-like motion and to enable the battery 502 to move in a motion indicated by arrow 509. As shown in FIG. 51, in one embodiment, each battery terminal is electrically coupled to a separate flexure suspension system 504. Accordingly, in one embodiment, two flexure suspension system 504 elements are used. It will be appreciated that a fewer or greater number of flexure suspension system 504 elements can be employed in other embodiments.

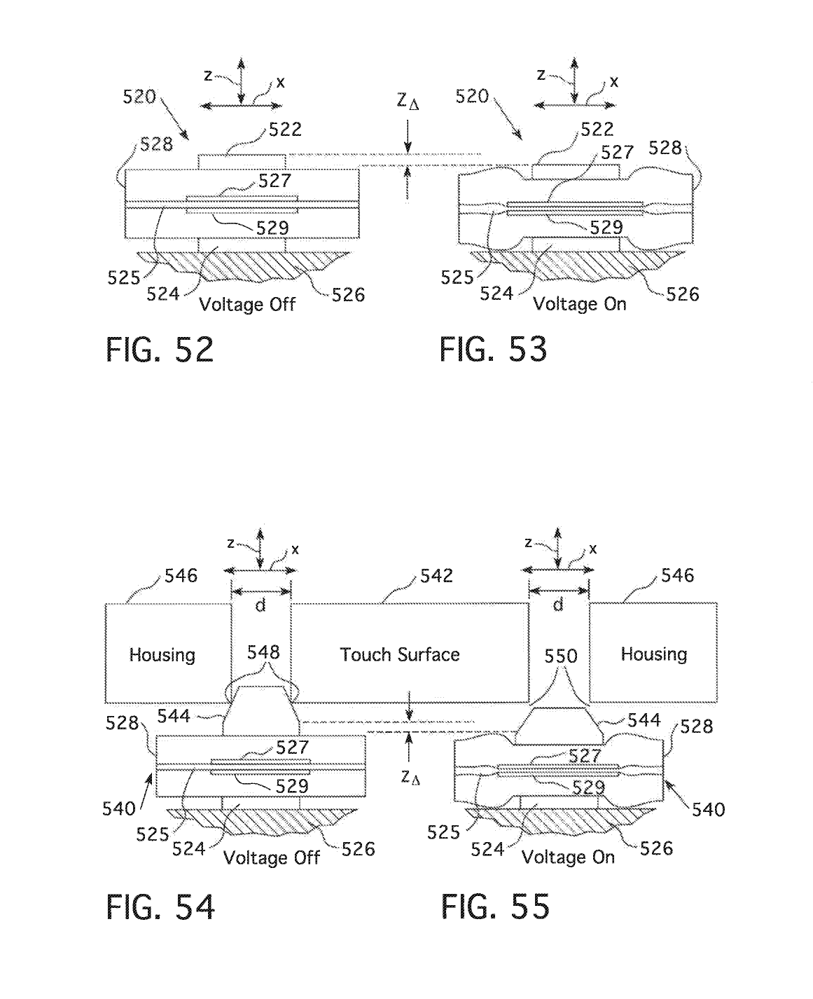

FIGS. 52-57 illustrate various embodiments of Z-mode actuators to actively dampen movement of a touch surface 542 in a mobile device. The Z-mode direction refers to the direction in which a push button type force would be applied to a touch surface 542 of a mobile device rather than a sliding force associated with gesturing, for example. Haptic actuators coupled to a touch surface 542 provide tactile feedback when energized to give the user a sensation such as the “button click” felt when pressing a real button or a texture or gesture associated with a particular activity. Additionally, the haptic actuators may be configured to give the user different sensations for different activities, e.g. having each button feel different so the user can tell their position on the virtual keypad. Embodiments of a mobile device utilizing a sliding mechanism with haptic actuators to move a touch surface 542 are described in connection with FIGS. 29-37, as an example. The compliance of the touch surface 542 sliding mechanism should be low to enable the use of lower power haptic actuators to more easily move the touch surface 542 laterally within a clearance gap “d” (FIGS. 54-57) provided around the perimeter of the touch surface 542 between the housing 546. When the haptic actuator is not energized, however, the touch surface 542 may feel loose and may move around slightly within the gap “d.” Accordingly, in one embodiment, a bumper module comprising one or more active bumpers 520, 540, 560 can be employed to dampen the motion of the touch surface 542 when the tactile feedback is not needed. The active bumpers 520, 540, 560 comprise movable output bar bumper stops 522, 544, 564 configured to engage the touch surface 542. In one embodiment, the touch surface 542 dampening functionality may be implemented using Z-mode bumpers that retract when the active bumper 520, 540, 560 is energized (e.g., powered on).

FIG. 52 is a sectional side view of one embodiment of a Z-mode active bumper 520 comprising a bumper actuator 528 coupled to a first output bar bumper stop 522, where the haptic actuator is de-energized. The bumper actuator 528 comprises a flexible membrane 525 located between first and second electrodes 527, 529. FIG. 53 is a sectional side view of the Z-mode active bumper 520 shown in FIG. 52, where the Z-mode active bumper 520 is energized. FIGS. 52-53 will now be described to illustrate the concept of the Z-mode active bumper 520 generally. Although the embodiments illustrated in FIGS. 52-53 are described in respect to operation in the Z-direction, it will be appreciated that the illustrated embodiments may be adapted and configured to operate in any direction. Accordingly, the Z-mode active bumper 520 changes configuration when a high voltage power source is switched from “off” to “on” and a drive voltage is applied to the first and second electrodes 527, 529 of the bumper actuator 528. The active bumper 520 comprises two output bars, the first (e.g., top) output bar bumper stop 522 and a second (e.g., bottom) output bar 524 with the bumper actuator 528 located therebetween. The first output bar bumper stop 522 is free to move in the Z-direction while the second plate is fixedly coupled to a mounting surface 526, which acts as a mechanical ground. In FIG. 52, the voltage is “off” such that the bumper actuator 528 is not energized. FIG. 53 illustrates the active bumper 520 after the application of an energizing voltage to the first and second electrodes 527, 529 of the bumper actuator 528. The energizing voltage causes the flexible membrane 525 to contract in the vertical direction (Z) and expand in the horizontal direction (X) under electrostatic pressure, which, in the disclosed embodiment, is harnessed as motion in the Z-direction. The amount of motion or displacement Z_{Δ} is proportional to the magnitude of the input voltage, among other variables. It can be amplified by the use of one or more compliant layers located between the electrode 527, 529 and the output bar 522, 524 which can contract in the vertical direction (Z) and expand in the horizontal direction (X) due to coupling with the flexible membrane 525 and electrode 527, 529.

FIGS. 54-55 illustrate one embodiment of a Z-mode active bumper 540 to actively dampen the movement of a touch surface 542 of a mobile device. FIG. 54 is a sectional view of one embodiment of a Z-mode haptic bumper 540 comprising a compliant bumper stop 544 coupled to a de-energized bumper actuator 528, i.e., the voltage is off. The haptic bumper 540 restricts or reduces the movement of the touch surface 542 when de-energized. In the embodiment shown in FIG. 54, the first (e.g., top) output bar comprises a compliant bumper stop 544 having a frustro-conical configuration with a sloping side wall and is made of a compliant material. In another embodiment (not shown), the bumper stop 544 may be in the form of a strip having sloping walls extending for some length along a gap. In the de-energized or “off” state the compliant bumper stop 544 is wedged between the touch surface 542 and the housing 546 to reduce or eliminate the clearance between the housing 546 and the touch surface 542 at contact area 548. FIG. 55 illustrates the active bumper 540 in an energized state, i.e., the voltage is “on.” In the energized state, the compliant bumper stop 544 is retracted in the Z-direction creating a gap 550 when the bumper actuator 528 contracts in the vertical direction (Z) and expands in the horizontal direction (X) under electrostatic pressure. The retracted compliant bumper stop 544 creates a gap 550 next to its side wall to expose a clearance between the touch surface 542 and the housing 546 to enable the touch surface 542 to move laterally within the gap “d.” In the embodiment shown in FIGS. 54-55, the compliant bumper stop 544 is made of a deformable stretchable material that can stretch laterally in the X-direction and shrink in the Z-direction due to material incompressibility. The amount of dampening depends on the compliance of the side wall of the compliant bumper stop 544. The effectiveness of the deformability of the compliant bumper stop 544 in dampening the motion of the touch surface 542 depends on the ability of the material to have suitable compliance to deform while having suitable mechanical integrity to serve as a stop when engaged with the touch surface 542 and the housing 546 at the contact area 548.

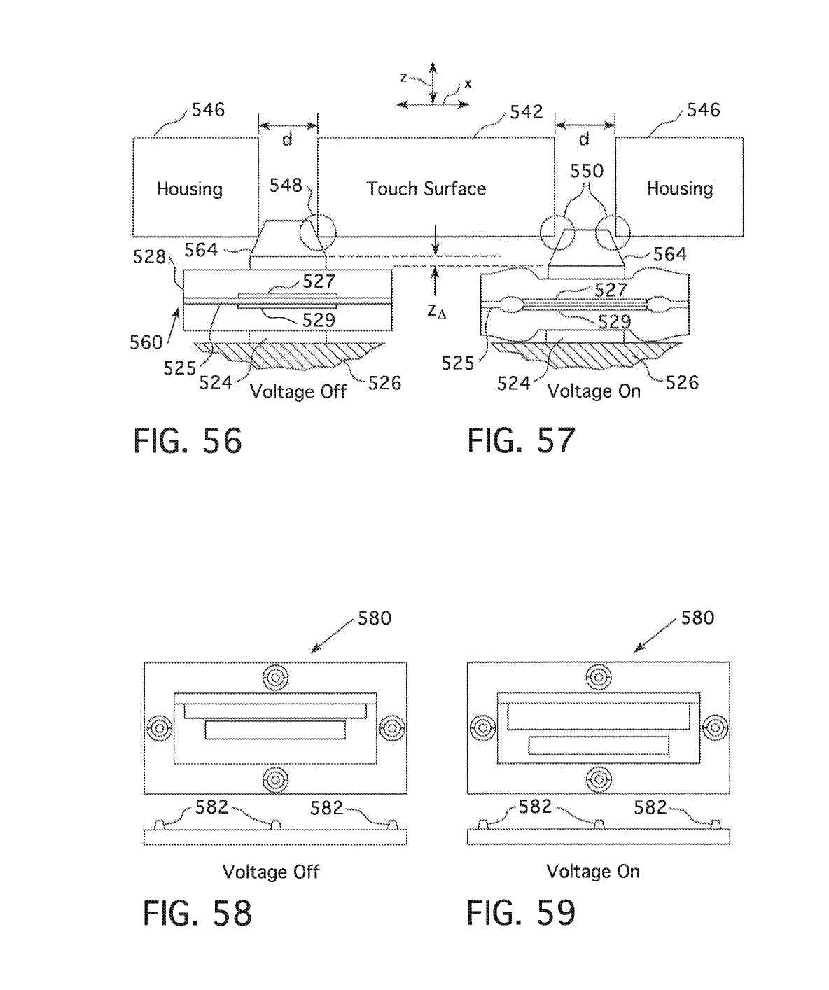

FIGS. 56-57 illustrate another embodiment of a Z-mode active bumper 560 to actively dampen the movement of the touch surface 542 of a mobile device. FIG. 56 illustrates one embodiment of a bumper actuator 528 in a de-energized state, i.e., the voltage is “off.” In the de-energized state the active bumper 560 restricts or reduces the movement of the touch surface 542. FIG. 57 illustrates the bumper actuator 528 in an energized state, i.e., the voltage is “on.” In the energized state, the active bumper 560 is retracted to enable the movement of the touch surface 542. In the embodiment shown in FIG. 56, an output bar bumper stop 564 has a frustro-conical configuration where the side wall reduces or eliminates any gaps between the housing 546 and the touch surface 542 at contact area 548. The amount of reduction depends on the compliance of the side walls of the top output bar bumper stop 564. In FIG. 57, the active bumper 560 is energized, i.e., the voltage is “on,” the bumper stop 564 retracts in the Z-direction creating gap 550 that allows the touch surface 542 to move laterally within the clearance “d” between the touch surface 542 and the housing 546. In the embodiment shown in FIGS. 56-57, the top bumper stop 564 is made of a non-deformable material such that the bumper stop 564 does not substantially stretch laterally in the X-direction and shrink in the Z-direction due to material incompressibility. The effectiveness of the non-deformable bumper stop 564 in dampening the motion of the touch surface 542 depends on the ability of the material to resist deformation in order to provide suitable mechanical integrity to serve as a stop or a bumper for the touch surface 542.

FIGS. 58-59 illustrate one embodiment of an integrated bumper and haptic actuator. FIG. 58 illustrates one embodiment of an integrated bumper and haptic actuator 580 in a de-energized state, i.e., voltage “off.” The Z-mode active bumpers 582 are extended (e.g., tall) and restrict the movement of the touch surface or any intertial mass in the de-energized state. FIG. 59 illustrates one embodiment of the integrated bumper and haptic actuator 580 shown in FIG. 56 in an energized state, i.e., voltage “on.” The Z-mode haptic bumpers 582 retract to allow touch surface motion. The haptic actuator is then able to move the touch surface laterally.

FIGS. 60-63 illustrate various embodiments of a clip-on flexure to secure first and second plates of a haptic module. For example, briefly referencing FIG. 1, the haptic module 10 comprises a first plate, i.e., a first output plate 12 (e.g., sliding surface) and a second fixed plate 14 (e.g., fixed surface), where the first output plate 12 moves relative to second fixed plate 14. FIG. 60 illustrates one embodiment of an external clip-on flexure 600 for securing first and second plates of a haptic module. In one embodiment, the external clip-on flexure 600 comprises a longitudinally extending elongate body 602 and a first set of clips 633a, 603b to secure the first plate (e.g., top plate) and a second set of clips 605a, 605b to secure the second plate (e.g., bottom plate). The first and second set of clips 603a, 603b and 605a, 605b are offset in the vertical Y-direction by a distance d₁ substantially perpendicular to the longitudinally extending elongate body 602, where the distance d₁ would be the distance between the first and second plates once they are secured to the external clip-on flexure 600, and would be suitable to receive a haptic actuator between the first and second plates. The first set of clips 603a, 603b is offset in the vertical Y-direction by a distance g₁ to define an opening or slot to secure an edge of the first plate having a thickness up to g₁. The second set of clips 605a, 605b is offset in the vertical Y-direction by a distance g₂ to define an opening or slot to secure an edge of the second plate having a thickness up to g₂. In the illustrated embodiment, g₁=g₂, however, in other embodiments g₁≠g₂ and these dimensions can be different. The clips 603a, 603b, 605a, 605b are formed as substantially flat tongues that project outwardly from the body 602 and are roughly perpendicular to the body 602. The clips 603a and 605a are positioned in a face up orientation and the clips 603b and 605b are positioned in a face down orientation. Each of the clips 603a, 603b, 605a, 605b comprises corresponding teeth 604a, 604b, 606a, 606b, which have roughly 45° bends to securely attach to slots formed in the corresponding first and second plates. The clips 603b and 605b further comprise corresponding T-lances 607, 609, where pushing down on the T-lances 607, 609 with a sharp point bends down two ears diagonally, securing the plates to the external clip-on flexure 600. A vertical stiffening flange 608 is provided to eliminate unwanted flexing.

FIG. 61 illustrates one embodiment of an internal clip-on flexure 610 to secure top and bottom plates 618, 619 of a haptic module, according to various embodiments. In one embodiment, the internal clip-on flexure 610 comprises a longitudinally extending elongate body 612 and a first clip 614 to secure a first plate 618 (e.g., top plate) and a second clip 616 to secure a second plate 619 (e.g., bottom plate). The clips 614, 616 define a bend of radius “r.” The first clip 614 comprises a tab 615 that is bent downwardly and is configured to be received in a corresponding slot 618′ formed in the first plate 618. The second clip 616 comprises a tab 617 that is bent upwardly and is configured to be received in a corresponding slot 619′ formed in the second plate 619. The first and second clips 614, 616 are initially in the configuration shown in broken line 614′, 616′. The clips 614′, 616 are then crimped to the form shown in solid line as the clips 614, 616 are secured to the corresponding first and second plates 618, 619. As shown in FIG. 61, the clips 614, 616 define gaps in the Y-direction g₁ and g₂ to define openings or slots, which are suitable for receiving the corresponding first and second plates 618, 619. In the illustrated embodiment, g₁=g₂, however, in other embodiments g₁≠g₂ and these dimension can be different. Ribs 611 are provided to reinforce the body 612 of the internal clip-on flexure 610 to prevent unwanted bending. The first and second clips 614, 616 are offset in the vertical Y-direction by a distance d₁ substantially perpendicular to the longitudinally extending elongate body 612, where d₁ is the distance between the first and second plates 618, 619 once they are secured to the internal clip-on flexure 610, and would be suitable to receive a haptic actuator between the first and second plates 618, 619.

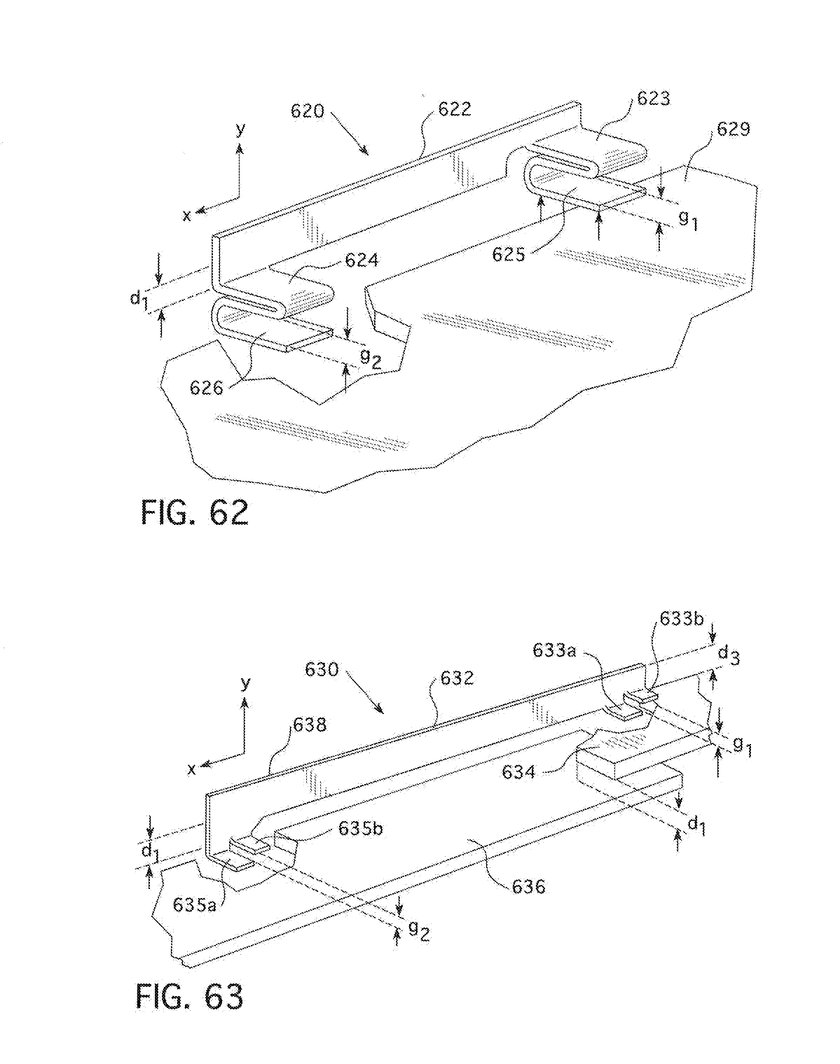

FIG. 62 illustrates one embodiment of an external clip-on flexure 620 to secure top and bottom plates of a haptic module, according to various embodiments. In one embodiment, the external clip-on flexure 620 comprises a longitudinally extending elongate body 622 and a first clip 623 defining a space 625 in the vertical Y-direction of g₁ to define an opening or slot for receiving an edge of a first plate (not shown) and a second clip 624 defining a space 626 in the vertical Y-direction of g₂ to define an opening or slot for receiving an edge of a second plate 629. As shown in FIG. 62, the clips 623, 624 are offset in the Y-direction by a distance d₁ substantially perpendicular to the longitudinally extending elongate body 622, where d₁ is the distance between the first and second plates. The clip 623 is configured to engage an edge of the first plate (not shown) within the space 625 and the clip 624 is configured to engage an edge of the second plate 629 within the space 626, such that the first and second plates are stacked vertically in the Y-direction with a space d₁ defined therebetween, and would be suitable to receive a haptic actuator between the first and second plates. In the illustrated embodiment, g₁=g₂, however, in other embodiments g₁≠g₂ and these dimensions can be different.

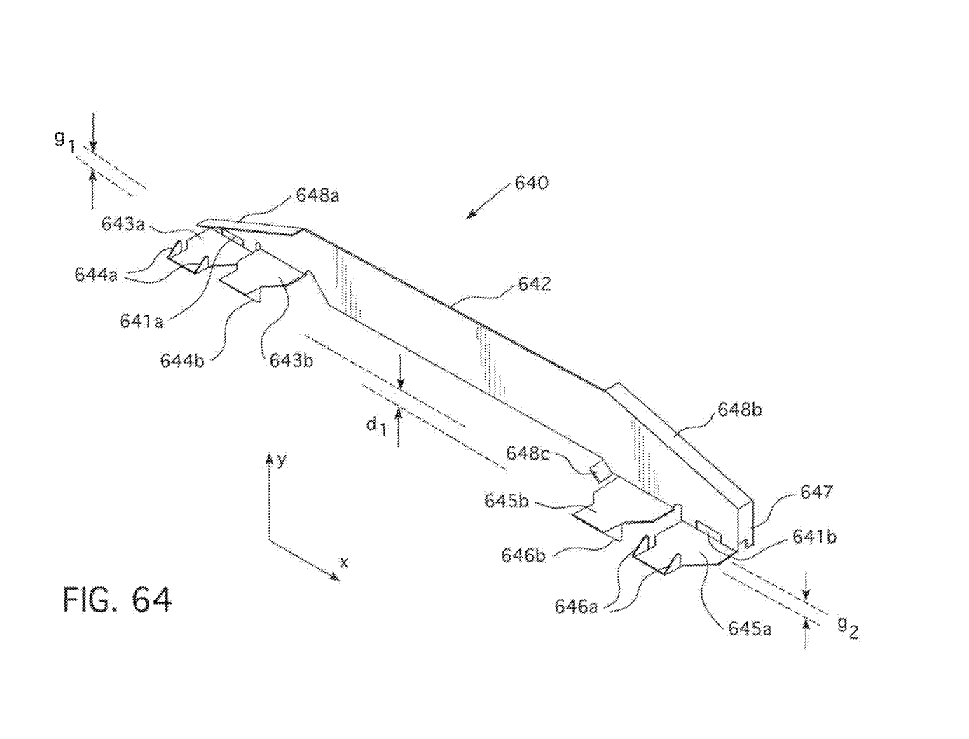

FIG. 63 illustrates one embodiment of an external clip-on flexure 630 to secure first and second plates of a haptic module, according to various embodiments. In one embodiment, the external clip-on flexure 630 comprises a longitudinally extending elongate body 632 and a first set of clips 633a, 633b to secure a first plate 634 (e.g., top plate) and a second set of clips 635a, 635b to secure a second plate 636 (e.g., bottom plate). The first and second set of clips 633a, 633b and 635a, 635b are offset in the vertical Y-direction by a distance d₁ substantially perpendicular to the longitudinally extending elongate body 632, where d₁ is the distance between the first and second plates 634, 636 once they are secured to the external clip-on flexure 630. The first set of clips 633a, 633b is offset in the vertical Y-direction by a distance g₁ to define an opening or slot to secure an edge of the first plate 634 having a thickness up to g₁, and would be suitable to receive a haptic actuator between the first and second plates 634, 636. The second set of clips 635a, 635b is offset in the vertical Y-direction by a distance g₂ to define an opening or slot to secure an edge of the second plate 636 having a thickness up to g₂. In the illustrated embodiment, g₁=g₂, but in other embodiments g₁≠g₂ and these thicknesses can be different. The clips 643a, 643b, 645a, 645b are formed as substantially flat tongues that project outwardly from the body 642 and are roughly perpendicular to the body 642, see FIG. 64.

FIG. 64 illustrates one embodiment of an external clip-on flexure 640 to secure top and bottom plates of a haptic module, according to various embodiments. In one embodiment, the external clip-on flexure 640 comprises a longitudinally extending elongate body 642 and a first set of clips 643a, 643b to secure a first plate (e.g., top plate) and a second set of clips 645a, 645b to secure a second plate (e.g., bottom plate). The first and second set of clips 643a, 643b and 645a, 645b are offset in the vertical Y-direction by a distance d₁ substantially perpendicular to the longitudinally extending elongate body 622, where d₁ is the distance between the first and second plates once they are secured to the external clip-on flexure 640, and would be suitable to receive a haptic actuator between the first and second plates. The first set of clips 643a, 643b is offset in the vertical Y-direction by a distance g₁ to define an opening or slot to secure an edge of the first plate having a thickness up to g₁. The second set of clips 645a, 645b is offset in the vertical Y-direction by a distance g₂ to define an opening or slot to secure an edge of the second plate having a thickness up to g₂. In the illustrated embodiment, g₁=g₂, however, in other embodiments g₁≠g₂ and these dimensions can be different. The clips 643a, 643b, 645a, 645b are formed as substantially flat tongues that project outwardly from the body 642 and are roughly perpendicular to the body 642. The clips 643a and 645a are positioned in a face up orientation and the clips 643b and 645b are positioned in a face down orientation. Each of the clips 643a, 643b, 645a, 645b comprises corresponding teeth 644a, 644b, 646a, 646b, which have roughly 90° bends to securely attach to slots formed in the corresponding plates. A pair of slots 641a, 641b is provided to receive tabs formed on the first and second plates. The slot 641a receives a tab from the first plate whereas the slot 641b receives a tab from the second plate. A vertical stiffening flange 647 is provided to eliminate unwanted flexing. Angled stiffening flanges 648a, 648b, 648c are provided to eliminate unwanted flexing above the clips 643a, 643b, 645a, 645b.

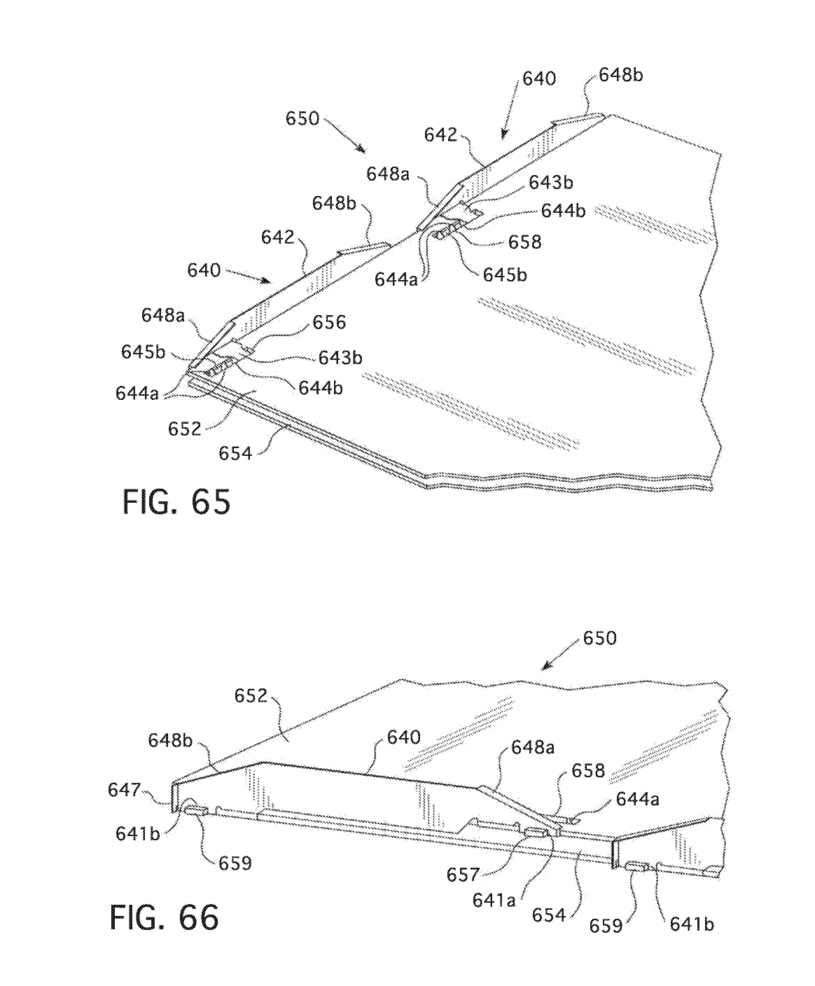

FIGS. 65-66 are perspective views of one embodiment of an external clip-on flexure 640 secured to top and bottom plates 652, 654 of a haptic module 650, according to one embodiment. With reference to FIG. 65, one set of clips 643a, 643b of the external clip-on flexure 640 are inserted into the slots 656, 658 formed in the top plate 652. The other set of clips 645a, 645b are inserted in respective slots, but are not shown because the top plate 652 obstructs the view. The teeth 644a, 644b are shown inserted into the slots 656, 658 to retain the clips 643a, 643b to the top plate 652. Although, not shown because the top plate 652 obstructs the view, the teeth 646a, 646b of the clips 645a, 645b are also inserted into corresponding slots formed in the bottom plate 654. Turning now to FIG. 66, a rear view of the external clip-on flexure 640 is shown secured to the top and bottom plates 652, 654. In this view, tabs 657, 659 formed in the top and bottom plates 652, 654 are shown inserted into corresponding slots 641a, 641b.

Each of the external clip-on flexures 600, 610, 620, 630, 640 can be formed from a single flat piece of sheet metal. In various embodiments, the external clip-on flexures 600, 610, 620, 630, 640 can be formed of a variety of metals such as copper, aluminum, tin, steel, titanium, or any suitable alloys thereof, such as brass, bronze, stainless steel, among others. More particularly, the clip-on flexures may be formed from stainless steel (SS), including without limitation 302 SS, 304 SS, 316 SS, for example. In one embodiment, the clip-on flexures can be stamped as a single component or may be used as a starting for drawing a photomask and then bent into the final form.

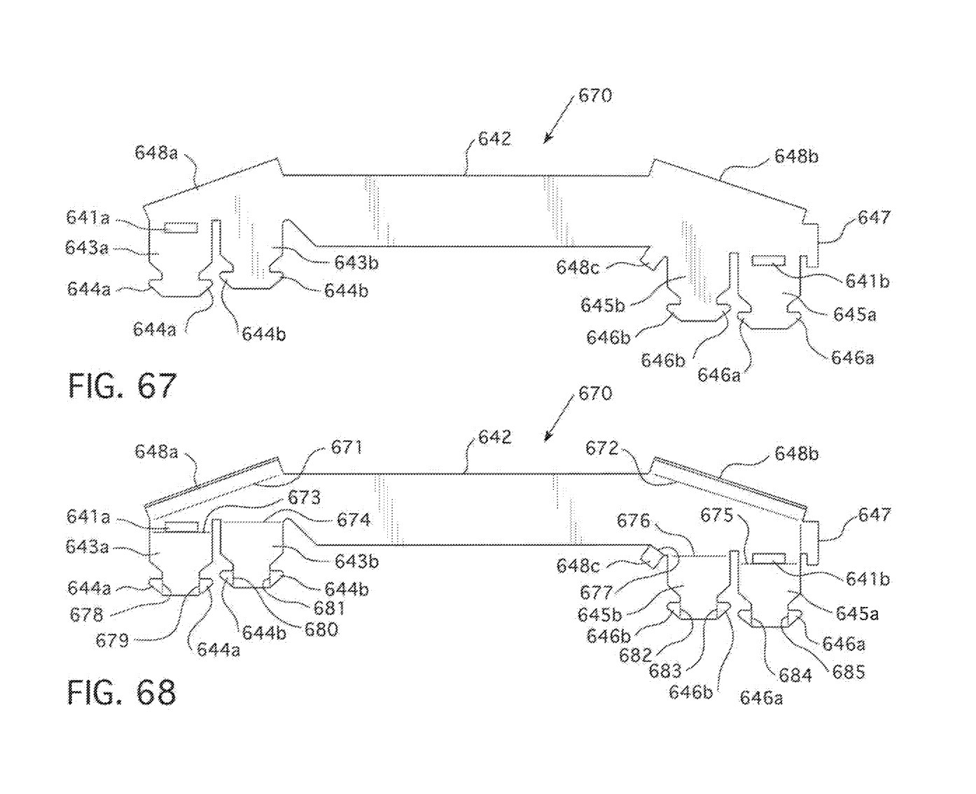

FIGS. 67-68 illustrates one embodiment of a single flat metal component 670, which can be bent to form the external clip-on flexure 640 described in connection with FIGS. 64-66. FIG. 67 is a rear view of the flat component 670 and FIG. 68 is a front view of the flat component 670. The various elements of the external clip-on flexure 640 such as the slots 641a, 641b, body 642, clips 643a, 643b, 645a, 645b, teeth 644a, 644b, 646a, 646b, vertical stiffening flange 647, and angled stiffening flanges 648a, 648b, 648c. In addition, FIG. 68 also shows the bend lines to form the final configuration of the external clip-on flexure 640. Bend lines 671, 672, and 677 are used to form the angled stiffening flanges 648a, 648b, 648c. Bend lines 673, 674, 675, 676 are used to form the clips 643a, 643b, 645a, 645b. Bend lines 678, 679 are used to form the teeth 644a of the clip 643a. Bend lines 680, 681 are used to form the teeth 644b of the clip 643b. Bend lines 682, 683 are used to form the teeth 646b of the clip 645b. Bend lines 684, 685 are used to form the teeth 646a of the clip 645a.

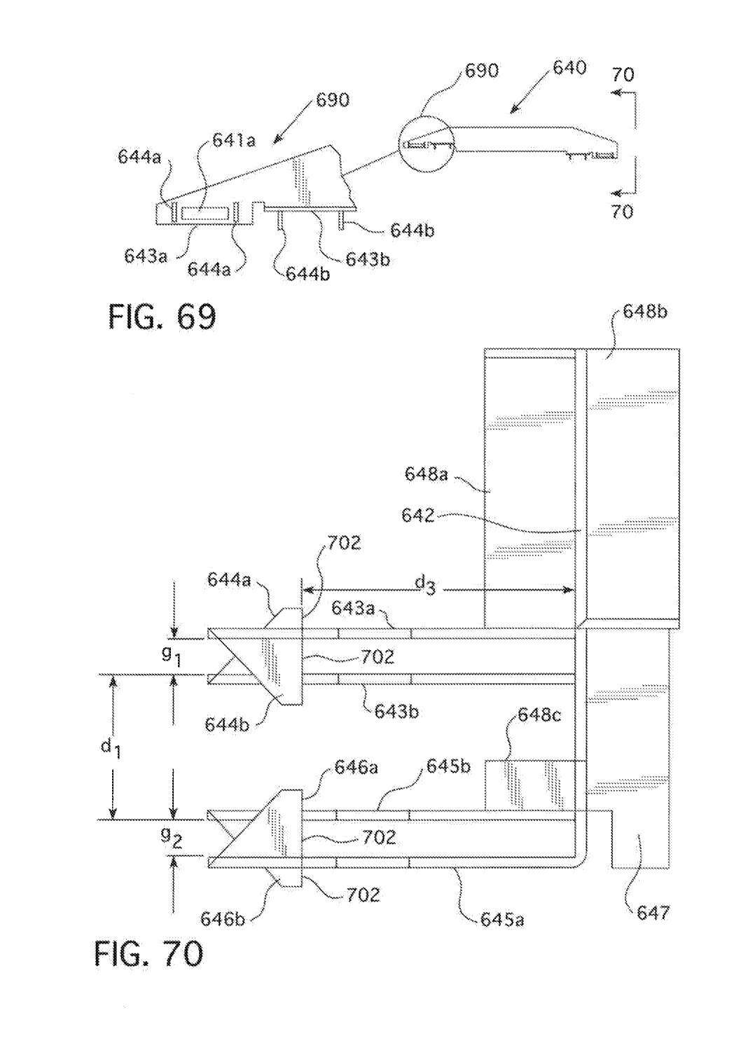

FIG. 69 illustrates a detail front view of one end portion 690 of the external clip-on flexure 640 described in connection with FIGS. 64-66. The end portion 690 of the external clip-on flexure 640 shows the teeth 644a, 644b in a normal orientation with respect to the base portion of the respective clips 643a, 643b.

FIG. 70 is a detail side view of the external clip-on flexure 640 along lines 70-70 in FIG. 69. As shown ion FIG. 70, the clearance between the bottom of the clip 643b and the top of the clip 645b is “d₁,” which is also shown in FIG. 64. The distance d₁ between these clips 643b, 645b define the space between the top and bottom plates. Also shown in detail is the clearance “g₁” between the bottom clip 643a and the top clip 643b and the clearance “g₂” between the bottom clip 645a and the top clip 645b. The clearances “g₁” and “g₂” are shown in FIG. 64. The side view also shown the relative orientation of the angled stiffening flanges 648a, 648b, 648c and the vertical stiffening flange 647 and the clearance “d3” between the vertical wall of the body 642 and the near vertical edge 702 of the teeth 644a, 644b, 646a, 646b.

Having described various embodiments of flexures that may be integrated with various embodiments of haptic actuators according to the present disclosure, the description now turns to flexure design considerations such as size of the flexure and loads that tend to un-bend the metal structure. In regards to size, in some applications there can be very small separations between the plates (e.g., d₁). For example, in one embodiment, a haptic module may have a plate separation of about 0.8 mm. Use of an internal flexure with such narrow plate separations would not be practical. In such applications, external flexures may be more practical. Internal flexures may be useful for inertial drives (battery shaker) where space is at less of a premium. In regards to loads that un-bend the metal, during impact test (300 g typical) a 25 g screen acts like a static load of 7.5 kg. That is the equivalent of having 15 pounds trying to tear the screen off the suspension. Accordingly, hard stops are employed to carry the high impact loads, as previously described.

Some additional information for consideration associated with flexure design includes performance specification, material properties, and deflection properties. In regards to performance specifications, considerations include stiffness in the direction of travel, normal load on each flexure to cause buckling, stiffness in normal direction each flexure must provide before buckling occurs to prevent grounding out the actuator, and drop-test load that suspension must withstand without exceeding yield stress in the flexures.

Stiffness in the direction of travel is defined as:

kₜ<(0.2*Blocked Force of Actuator)/(Travel)

kₜ<(0.2*0.19 N)/(0.2E−3 m)

kₜ<190 N/m

The normal load on each flexure to cause buckling is given by:

F_{buckle}=(F_{keypress})*(safety factor)/(#flexures)

F_{buckle}=(60 gramf)*(4)/(4)

F_{buckle}=60 gramf=0.6 N

Stiffness in the normal direction each flexure must provide before buckling occurs, to prevent grounding out the actuator is given by:

kₙ>(F_{buckle})/(smallest clearance in can)

kₜ>(0.6 N)/(0.1E−3 m)

kₜ<60,000 N/m

Drop-test load that suspension must withstand without exceeding yield stress in the flexures (σₘₐₓ), where typical acceleration inside a mobile phone case subjected to 1 m drop=300 g, as described in C. Y. Zhou, T. X. Yu, Ricky S. W. Lee, Drop/impact Tests and Analysis of Typical Portable Electronic Devices, International Journal of Mechanical Sciences 50 (2008) 905-917, which is incorporated herein by reference.

Effective mass=(screen mass)*(acceleration in g)

Effective mass=(0.025 kg)*(300)=7.5 kg

F_{drop}=(0.025 kg)*(300)*(9.8 N/kg)

F_{drop}=70 N

Material Properties

Tensile Modulus (all tempers of 304 Stainless Steel):

Y=˜200-210 GPa

Ultimate Strength of Stainless Steels:

σₘₐₓ=0.8-2 GPa(temper dependent)

Yield Strength (temper dependant) is shown in TABLE 4.

TABLE 4

| Temper | Yield Strength (MPa) |
|---|---|
| 304 Soft | (215 typ)-596 (max) |
| 316 soft | 415 |
| 304 ¼ hard | 880 |
| 304 ½ hard | 1000 |
| 304 ¾ hard | 1140 |
| 301 | 1400 |

Fatigue Limit

σₘₐₓ=200-500 MPa(temper dependent,use 200 MPa)

∈ₘₐₓ=˜0.1%

Additional information on materials can be found at the world-wide-web web site designated as “calce.umd.edu/general/Facilities/Hardness_ad_.htm.”

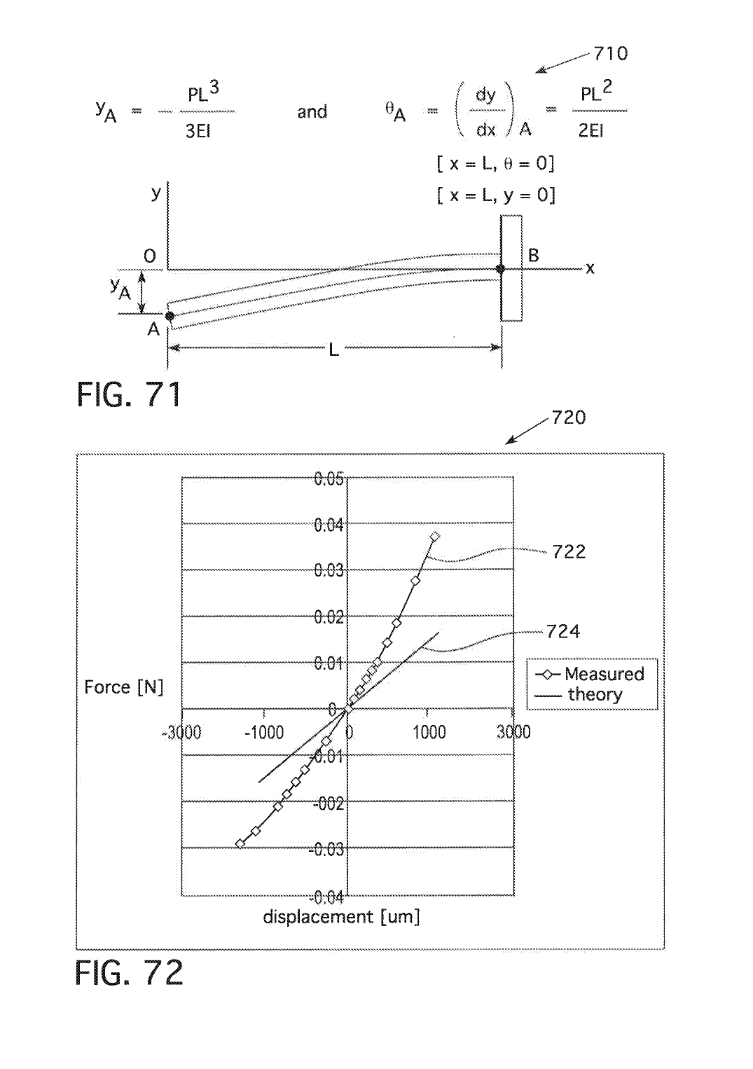

FIG. 71 is a schematic diagram 710 representation of the deflection of a simple cantilever beam. With reference to FIG. 71, the deflection of a simple cantilever beam can be analyzed as follows:

P=load [N] on Point A

L=beam length [m]

E=Young's Modulus [N/m²]

I=Moment of inertia in bending. For a rectangular cross section I=bt³/12

Inserting the moment of inertia (I) into the equation yields the expression:

$${y}_{a} = \frac{12 {PL}^{3}}{{Ebt}^{3}}$$

Solving for bending stiffness (k=P/y) yields the expression:

$$k = \frac{b E}{12} ( \frac{{t}^{3}}{{L}^{3}} )$$

Note that if both the thickness (t) and length (L) of a beam are both doubled, bending stiffness remains unchanged.

Additional information on beam deflection analysis can be found at Beer, F. P., Johnston, E. R., Mechanics of Materials, McGraw Hill (1992), which is incorporated herein by reference.

With the above background in mind, the force to move a fixed-guided flexure in travel direction, will now be described. Moving a fixed-guided flexure is equivalent to two fixed-free beams of length (L/2), arranged in series, where the stiffness for each beam is given by the expression:

$$k\_half = \frac{2 b E}{3} ( \frac{{t}^{3}}{{L}^{3}} )$$

Two such springs in mechanical series are half as stiff as one alone

$$k = \frac{b E}{12} ( \frac{{t}^{3}}{{L}^{3}} ) \qquad EQ . 1$$

The force required to move to position d is simply F=kd.

FIG. 72 is a graphical representation 720 illustrating the agreement between theory and measurement of a steel flexure, plotted against values expected from EQ. 1. The horizontal axis represents displacement (μm) and the vertical axis represents force (N). A strip of 0.002″ stainless steel shim was cut to 2.2 mm width, and supported in a fixed-guided configuration, with one side attached to a force gage on a micro-positioner and the other side grounded. Force and displacement were measured and plotted as curve 722. Theoretical stiffness was calculated according to EQ. 1, and is also shown as curve 724. In this comparison, theory based on first principles underestimates force by about 2-fold, but gives the right order of magnitude. Thus, EQ. 1 is a useful tool for rough design.

The principle of virtual work can be applied to Howell's spring-strut approximation for flexures, as discussed hereinbelow. The useful result is the equation below:

$$F ( x ) = \frac{8 γ {K}_{Θ} h {t}^{3} E}{3 {l ( {γ}^{2} {l}^{2} - {x}^{2} )}^{0.5}} {sin}^{- 1} ( \frac{x}{γ l} )$$

Where:

F=force required to deflect to position (x) [N]

h=height of the flexure [m]

t=thickness of the flexure [m]

l=length of flexure when straight

E=Young's modulus [N/m²] (modulus of elasticity)

x=transverse displacement from rest position [m]

γ=0.8517

K_{Θ}=2.67617

As an example, consider a steel flexure that is (1.0 mm tall×3 mm long×0.012 mm thick). The flexure needs to travel 0.1 mm with an acceptably small force (e.g., <20% of the available actuation force), where:

$$h = 1.0 E - 3 [ m ]$$

$$t = 0.012 E - 3 [ m ]$$

$$l = 3 E - 3 [ m ]$$

$$E = 200 E 9 [ N \text{/} {m}^{2} ]$$

$$x = 0.1 E - 3 [ m ]$$

$$F ( x ) = \frac{8 γ {K}_{Θ} h {t}^{3} E}{3 {l ( {γ}^{2} {l}^{2} - {x}^{2} )}^{0.5}} {sin}^{- 1} ( \frac{x}{γ l} )$$

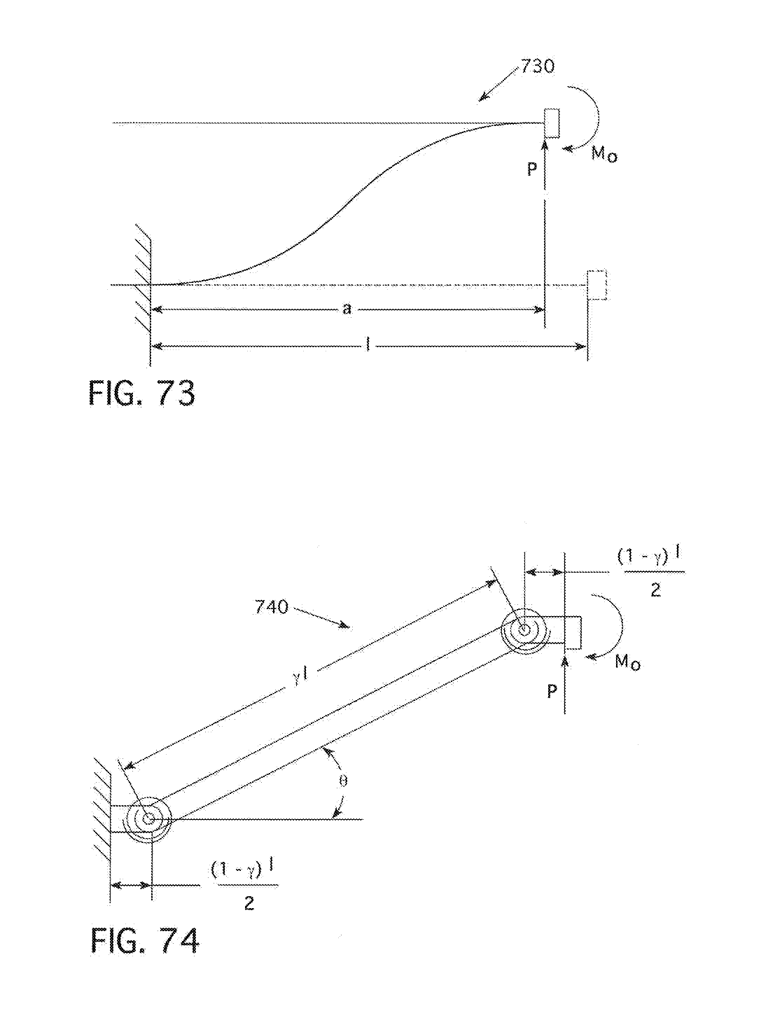

A rigid body approximation of flexure is now described with reference to FIGS. 73 and 74, where a useful approximation for the kinematics and stiffness of a flexure is treating the flexure as three rigid links joined by two torsional springs. Additional information may be found at Howell, L. L, Compliant Mechanisms, John Wiley and Sons, Inc. (2001) [151, 163-164].

The spring rate of each torsional spring is provided by:

$$K = 2 γ {K}_{Θ} \frac{EI}{l}$$

K=torsional spring constant (Nm/radian)
E=Young's modulus [N/m2]
I=Moment of inertia in bending
l=length of beam when straight
Geometry—dependent scaling factors
γ=0.8517
K_{Θ}=2.67617

FIGS. 73 and 74 are schematic diagrams 730, 740 of torsional springs. Referring now to FIGS. 73 and 74, it is noted that there are two torsional springs that generate torque in proportion to angle (θ). Integrating, it can be seen that the potential energy stored by the two torsional springs is associated with the angle (θ) squared.

$${τ}_{spring} = K θ$$

$${U}_{spring} = {\int }_{0}^{θ 1} τ d θ$$

$${U}_{spring} = K {\int }_{0}^{{θ}_{1}} θ d θ$$

$${U}_{spring} ( θ ) = K {θ}^{2}$$

Note that there are two virtual springs in one flexure:

U_{flex}(θ)=2Kθ²

It should also be noted that the angle (θ) of the rigid body mechanism can be expressed in terms of displacement of the mechanism from straight to some new location (x) as follows:

$$sin θ = \frac{x}{γ l} -> θ = {sin}^{- 1} ( \frac{x}{γ l} )$$

Now the elastic potential energy can be expressed with respect to displacement of the mechanism as follows:

$$U = 2 {K [ {sin}^{- 1} ( \frac{x}{γ l} ) ]}^{2}$$

Energy stored in elastic deformation of the flexure is be provided by an equal amount of work (∫Fdx) applied to linear motion of the flexure as follows:

$${\int }_{0}^{x} F ( x ) d x = 2 {K [ {sin}^{- 1} ( \frac{x}{γ l} ) ]}^{2}$$

Differentiating provides:

$$F ( x ) = \frac{d}{d x} 2 {K [ {sin}^{- 1} ( \frac{x}{γ l} ) ]}^{2}$$

$$F ( x ) = \frac{4 K}{{( {γ}^{2} {l}^{2} - {x}^{2} )}^{0.5}} {sin}^{- 1} ( \frac{x}{γ l} )$$

Substituting for torsional stiffness K, yields a compact expression for the force required to push the flexure to a distance x as follows:

$$F ( x ) = \frac{8 γ {K}_{Θ} b {t}^{3} E}{3 {l ( {γ}^{2} {l}^{2} - {x}^{2} )}^{0.5}} {sin}^{- 1} ( \frac{x}{γ l} ) \qquad EQ . 2$$

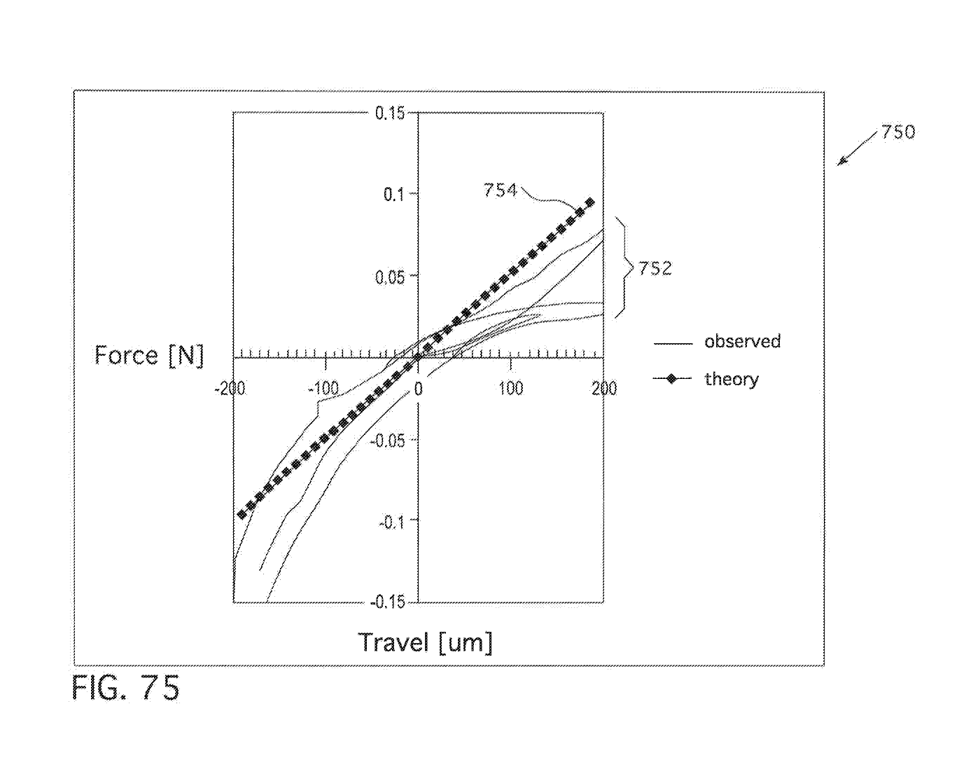

FIG. 75 is a graphical representation 750 of measurements of displacement versus reaction force. A suspension was prototyped with four flexures, each (1.0 mm tall×3.0 mm long×0.012 mm thick). Measurements 752 of displacement versus reaction force are shown in FIG. 75, where Travel (μm) is shown along the horizontal axis and Force (N) is shown along the vertical axis along with predicted values 754 according to EQ. 2. Although hysteresis and error are apparent in the measurements, the data agree well enough with theory to support the idea that EQ. 2 is a useful design tool.

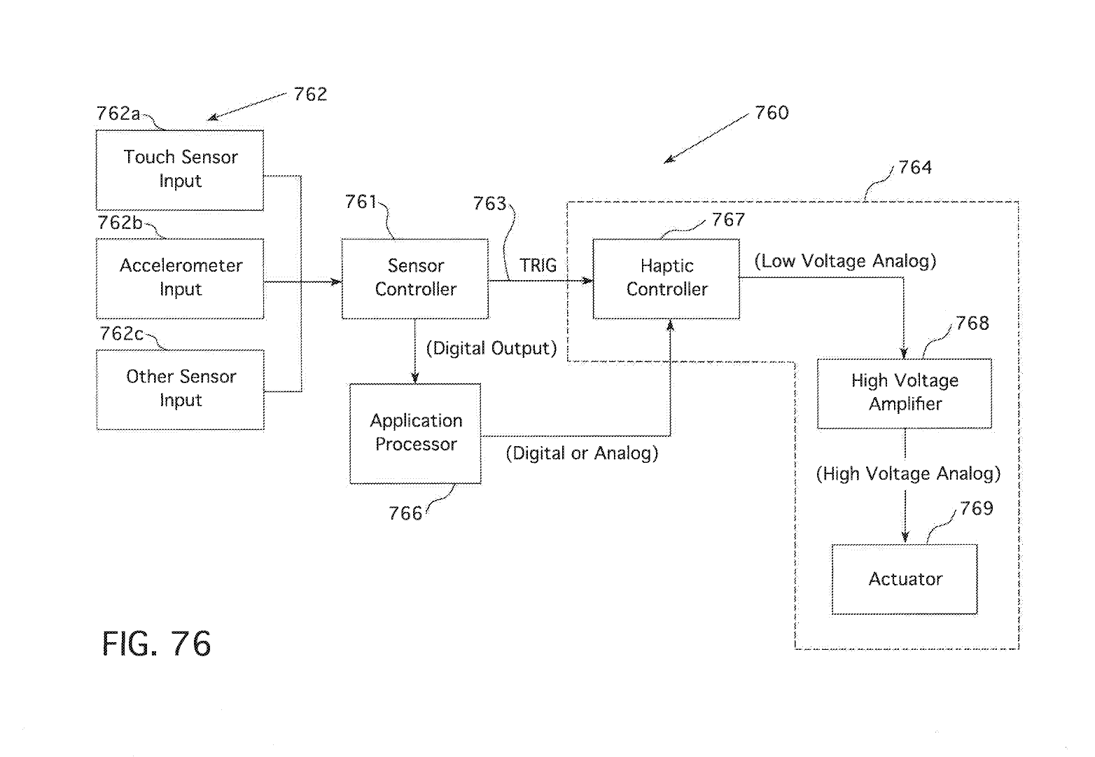

FIG. 76 is a system diagram 760 of an electronic control circuit for activating a haptic module 764 from a sensor input. According to one embodiment of the system 760, a sensor controller 761 monitors inputs from a variety of sensor input sources 762. The sensor input sources may comprise, for example, a touch sensor input 762a, an accelerometer input 762b, or other sensor input 762c. It will be appreciated that such sensor inputs 762 may be associated within a mobile device platform. Once the sensor controller 761 receives a sensor input from one of the sensor input sources 762, the sensor controller 761 provides an output signal to a haptic module 764. In one aspect, the sensor controller 761 may provide an analog output signal 763 (TRIG) to a haptic controller 767. In another aspect, the sensor controller 761 may provide a digital output signal 765 to an application processor 766. The application processor 766 may provide a digital or analog output signal to the haptic controller 767. The haptic controller 767 generates a low voltage analog output signal, which is provided to a high voltage amplifier 768. The high voltage analog output of the high voltage amplifier is then coupled to a haptic actuator 769, according to the various embodiments disclosed herein.

As used herein, the application processor 766 may be implemented as a host central processing unit (CPU), a slave microcontroller, or other suitable configuration, using any suitable processor circuit or logic device (circuit), such as a as a general purpose processor and/or a state machine. The application processor 766 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

In one embodiment, the application processor 766, or a host or slave microcontroller, may comprise a digital to analog converter (DAC) that can be employed to produce complex analog waveforms. Also, in one embodiment, the high voltage amplifier 768 may be based on a Maxim MAX8622 photoflash controller. The MAX8622 is a flyback switching regulator to quickly and efficiently charge high-voltage photoflash capacitors. It is well suited for use in digital, cell-phone, and smartphone applications that use either 2-cell alkaline/NiMH or single-cell Li+ batteries. An internal, low-on-resistance n-channel MOSFET improves efficiency by lowering switch power loss. In another embodiment, the high voltage amplifier may be a SUPERTEX 1 kV amplifier solution based on HV817 and LN100.

In one embodiment, the haptic controller 767 may be based on a Maxim MAX11835 integrated circuit to trigger stored waveforms via I²C or streaming analog. The MAX11835 is a haptic (tactile) actuator controller that provides a complete solution to drive haptic actuators to add haptic feedback to products featuring user-touch interfaces. The MAX11835 also drives actuators including single-layer, multilayer piezo, or electroactive polymer actuators. The device efficiently generates any type of user-programmable waveform including sine waves, trapezoidals, squares, and pulses to drive the piezo loads to create custom haptic sensations. The low-power device directly interfaces with an application processor or host controller through an I²C interface and integrates various blocks including a boost regulator, pattern storage memory, and waveform generator block in one package, thus providing a complete haptic feedback controller solution.

In one embodiment, TOUCHSENSE 5500 by Immersion, may be employed to execute Immersion TOUCHSENSE software to enhance haptic effects or tactile feedback produced by the haptic actuators built into devices to create vibrations, e.g., vibro-tactile feedback. The haptic actuators can be with Immersion TOUCHSENSE software to create haptic sensations, like the feel of a button “click” when a virtual button is pressed. Haptics provide a sense of realism and improve the user experience, and are found in consumer devices like mobile phones, tablets, and gaming controllers. In one embodiment, an Inter-Integrated Circuit (Streaming I²C) interface; generically referred to as “two-wire interface,” may be employed as a multi-master serial single-ended computer bus to attach low-speed peripherals to a motherboard, embedded system, cellphone, or other electronic device. I²C systems may be available from Siemens AG (later Infineon Technologies AG), NEC, Texas Instruments, STMicroelectronics (formerly SGS-Thomson), Motorola (later Freescale), Intersil, among others. A similar amplifier as in the DAC may be employed. A library of haptic effects may be created and stored in memory. In one embodiment, an audio processor—similar to that provided by Mophie Inc., may be employed to enhance haptic effects or tactile feedback produced by the haptic actuators built into devices.

Broad categories of previously discussed mobile devices include, for example, personal communication devices, handheld devices, and mobile telephones. In various aspects, a mobile device may refer to a handheld portable device, computer, mobile telephone, smartphone, tablet personal computer (PC), laptop computer, and the like, or any combination thereof. Examples of smartphones include any high-end mobile phone built on a mobile computing platform, with more advanced computing ability and connectivity than a contemporary feature phone. Some smartphones mainly combine the functions of a personal digital assistant (PDA) and a mobile phone or camera phone. Other, more advanced, smartphones also serve to combine the functions of portable media players, low-end compact digital cameras, pocket video cameras, and global positioning system (GPS) navigation units. Modern smartphones typically also include high-resolution touch screens (e.g., touch surfaces), web browsers that can access and properly display standard web pages rather than just mobile-optimized sites, and high-speed data access via Wi-Fi and mobile broadband. Some common mobile operating systems (OS) used by modern smartphones include Apple's IOS, Google's ANDROID, Microsoft's WINDOWS MOBILE and WINDOWS PHONE, Nokia's SYMBIAN, RIM's BLACKBERRY OS, and embedded Linux distributions such as MAEMO and MEEGO. Such operating systems can be installed on many different phone models, and typically each device can receive multiple OS software updates over its lifetime. A mobile device also may include, for example, gaming cases for mobile devices (IOS, ANDROID, Windows phones, 3DS), gaming controllers or gaming consoles such as an XBOX console and PC controller, gaming cases for tablet computers (IPAD, GALAXY, XOOM), integrated portable/mobile gaming devices, haptic keyboard and mouse buttons, controlled resistance/force, morphing surfaces, morphing structures/shapes, among others.

It is to be appreciated that the embodiments described herein illustrate example implementations, and that the functional elements, logical blocks, program modules, and circuits elements may be implemented in various other ways which are consistent with the described embodiments. Furthermore, the operations performed by such functional elements, logical blocks, program modules, and circuits elements may be combined and/or separated for a given implementation and may be performed by a greater number or fewer number of components or program modules. As will be apparent to those of skill in the art upon reading the present disclosure, each of the individual embodiments described and illustrated herein has discrete components and features which may be readily separated from or combined with the features of any of the other several embodiments without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, embodiments, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary embodiments and embodiments shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments and appended claims.

What is claimed is:

1. An actuator module, comprising:
an actuator disposed between first and second electrodes; and
a suspension system comprising at least one flexure coupled to the actuator, wherein the flexure enables the suspension system to move in a predetermined direction when the first and second electrodes are energized.

2. The actuator module according to claim 1, wherein the actuator comprises at least one elastomeric dielectric film disposed between first and second electrodes.

3. The actuator module according to one of claims 1 and 2, wherein the actuator is flat or planar.

4. The actuator module according to any one of claims 1 to 3, wherein the suspension system comprises at least one travel stop to limit movement of the suspension system in the predetermined direction.

5. The actuator module according to any one of claims 1 to 4, further including a flexure tray, wherein the flexure tray comprises the at least one flexure.

6. The actuator module according to claim 5, wherein the flexure tray comprises at least one travel stop to limit movement of the suspension system in the predetermined direction.

7. The actuator module according to claim 5, wherein the at least one flexure is formed integrally with the flexure tray.

8. The actuator module according to claim 5, wherein the flexure tray defines an opening to receive a battery therein.

9. The actuator module according to claim 5, wherein the actuator is coupled to the flexure tray on one side, and wherein the actuator is coupled to a mounting surface on the other side.

10. The actuator module according to any one of claims 1 to 9, wherein the actuator comprises first and second plates and wherein the flexure couples the first plate to the second plate.

11. A mobile device, comprising:
the actuator module according to any one of claims 1 to 10; and
a mass coupled to the actuator.

12. The mobile device according to claim 11, wherein the mass comprises a touch surface.

13. The mobile device according to one of claims 11 and 12, wherein the actuator module provides haptic feedback.

14. A mobile device, comprising an active bumper, the active bumper comprising:
a movable bumper stop configured to engage a mass within an actuator module; and
a bumper actuator having a first side coupled to the movable bumper stop and a second side coupled to a mounting surface;
wherein the movable bumper stop is configured to engage the mass when the bumper actuator is energized.

15. The mobile device according to claim 14, wherein the movable bumper stop comprises a compliant material configured to contract in a first direction and expand in a second direction when the bumper actuator is energized.

16. The mobile device according to any one of claims 11 to 14, further including:
a display subassembly coupled to a touch surface; and
a body subassembly coupled to the display subassembly, wherein the actuator is disposed between the display subassembly and the body subassembly.

17. The mobile device according to claim 16, wherein the body subassembly comprises slide rails configured to couple to the touch surface.

18. The mobile device according to claim 16, wherein the display subassembly comprises clips coupled to the touch surface and to the slide rails.

19. The mobile device according to claim 16, wherein the actuator is located within the body subassembly.

20. The mobile device according to any one of claims 16 to 19, wherein the body subassembly comprises at least one limit screw to provide a mechanical hard stop in a predetermined direction to limit movement.

21. The mobile device according to claim 11, comprising a housing comprising at least one electrical connection, wherein the housing is configured to receive a battery, wherein the flexure is configured to suspend the battery and to electrically couple the battery to the at least one electrical connection.

22. The actuator module according to claim 11, wherein the flexure comprises:
a longitudinally extending elongate body having a first end and a second end, the elongate body extending;
a first clip extending outwardly from the first end of the body, wherein the first clip is configured to engage an edge of the first plate; and
a second clip extending outwardly from the second end of the body, wherein the second clip is configured to engage an edge of the second plate;
wherein the first and second clips are offset in a direction substantially perpendicular to the longitudinally extending elongate body to define a gap between the first and second plates.

23. The actuator module according to claim 22, wherein the first and second clips each define a slot suitable to receive corresponding edges of the first and second plates.

24. The actuator module according to claim 22, wherein the first clip comprises first and second tongues and the second clip comprises first and second tongues, and wherein the first and second tongues of the first clip define a first slot to engage the edge of the first plate, and wherein the first and second tongues of the second clip define a second slot to engage the edge of the second plate.

25. The actuator module according to claim 24, wherein the first and second tongues of the corresponding first and second clips each comprise teeth configured to engage corresponding slots formed in the first and second plates.
